(19) United States
(12) Patent Application Publication
(10) Pub. No.: US 2026/0291966 A1
(43) Pub. Date: Sep. 24, 2026

(54) Programmatic Script Detection Using Sequential State Transitions

(71) Applicant: Cisco Technology, Inc., San Jose, CA (US)

(72) Inventors: Ania Kacewicz, Baltimore, MD (US); Rod Soto, Miami, FL (US); Jud Dagnall, San Jose, CA (US)

(21) Appl. No.: 19/085,762

(22) Filed: Mar. 20, 2025

(51) Int. Cl. H04L 9/40

(52) U.S. Cl. CPC H04L 63/1425; H04L 63/102; H04L 63/1433

(57) ABSTRACT

A computing device obtains log data comprising a plurality of log entries. The computing device sorts the plurality of log entries based on respective timestamps. The computing device identifies sequential blocks of log entries from the sorted set of log entries. The computing device performs a programmatic behavior analysis on the sequential blocks of log entries resulting in a determination as to whether the log entries were generated by repeated execution of a benign programmatic script. Responsive to determining the sequential blocks of log entries were not generated by repeated execution of the benign programmatic script, the computing device determines the log entries indicate anomalous behavior and initiating one or more automated remediation operations.

The present disclosure relates to addressing potential cybersecurity risks. More particularly, the present disclosure relates to detecting programmatic scripts.

### BACKGROUND

Various organizations, such as companies, government agencies, or financial institutions, or even individuals, implement cybersecurity systems and techniques to protect their computing environments against malicious behavior, such as brute force attacks in which malicious actors systematically try numerous username and password combinations in order to obtain unauthorized access to a user account, and typically as a result, sensitive data. Detecting malicious behavior is a difficult problem, and malicious actors are continually improving their techniques to exploit the computing systems of other individuals or organizations. Sophisticated malicious behavior, such as intelligent or calculated brute force attacks, often attempt to avoid detection by cybersecurity systems and techniques. For example, various intelligent brute force attacks may spread out the number of authentication attempts to avoid triggering an account lock-out mechanism that seeks to prevent traditional brute force attacks by locking a user account after a predetermined number of failed password attempts within a given time period.

Developers of cybersecurity systems and techniques similarly work to improve those cybersecurity systems and techniques. However, not all activity is malicious, and cybersecurity systems and techniques often attempt to differentiate benign activity from malicious activity within computing environments. This can be difficult, such as in situations where benign actors within the computing environment perform activity that in some ways resembles malicious activity.

### SUMMARY OF THE DISCLOSURE

Systems and methods for facilitating the detection of programmatic scripts in accordance with embodiments of the disclosure are described herein.

In a variety of embodiments, a method includes obtaining log data comprising a plurality of log entries, wherein each log entry includes an indicator of a state of an action or resource, and a timestamp. The method further includes sorting the plurality of log entries based on the timestamps resulting in a sorted set of log entries. The method further includes identifying sequential blocks of log entries from the sorted set of log entries, wherein each sequential block of log entries includes a same status of the action or the resource, and wherein each sequential block of log entries begins with a log entry indicating a different state of the action or the resource compared to an immediately prior log entry. The method further includes performing a programmatic behavior analysis on the sequential blocks of log entries resulting in a determination as to whether the log entries were generated by repeated execution of a benign programmatic script. The method further includes, responsive to determining the sequential blocks of log entries were not generated by repeated execution of the benign programmatic script, determining the log entries indicate anomalous behavior and initiating one or more automated remediation operations.

In a variety of embodiments, the log data is authentication log data comprised of a plurality of authentication attempt entries, wherein each authentication attempt entry includes an authentication attempt status and a timestamp.

In a variety of embodiments, the remediation operations include identifying a user account to which the authentication attempt entries correspond and locking the user account thereby preventing access thereto.

In a variety of embodiments, the log data is network transmission log data comprised of a plurality of network transmission attempt entries, wherein each of the plurality of network transmission attempt entries originate from a first source address and includes an indicator of a transmission attempt status and a timestamp.

In a variety of embodiments, the programmatic behavior analysis includes determining a sequence length for each of the sequential blocks. The programmatic behavior analysis further includes determining, based on the sequence length for each of the sequential blocks, whether a sequential pattern exists within the log entries that is indicative of repeated execution of a benign programmatic script. The programmatic behavior analysis further includes, responsive to a determination that no such sequential pattern exists within the log entries that is indicative of the repeated execution of the benign programmatic script, determining the log entries are indicative of anomalous behavior.

In a variety of embodiments, the one or more automated remediation operations includes adjusting a risk score associated with the log data in a cybersecurity system.

In a variety of embodiments, the method further includes, responsive to determining the sequential blocks of log entries were generated by repeated execution of the benign programmatic script, identifying the benign programmatic script.

In a variety of embodiments, a computing device includes a processor and a non-transitory computer-readable medium having stored thereon instructions that, when executed by the processor, cause the processor to perform operations. The operations include obtaining log data comprising a plurality of log entries, wherein each log entry includes an indicator of a state of an action or resource, and a timestamp. The operations further include sorting the plurality of log entries based on the timestamps resulting in a sorted set of log entries. The operations further include identifying sequential blocks of log entries from the sorted set of log entries, wherein each sequential block of log entries includes a same status of the action or the resource, and wherein each sequential block of log entries begins with a log entry indicating a different state of the action or the resource compared to an immediately prior log entry. The operations further include performing a programmatic behavior analysis on the sequential blocks of log entries resulting in a determination as to whether the log entries were generated by repeated execution of a benign programmatic script. The operations further include, responsive to determining the sequential blocks of log entries were not generated by repeated execution of the benign programmatic script, determining the log entries indicate anomalous behavior and initiating one or more automated remediation operations.

In a variety of embodiments of the computing device, the log data is authentication log data comprised of a plurality of authentication attempt entries, wherein each authentication attempt entry includes an authentication attempt status and a timestamp.

In a variety of embodiments of the computing device, the remediation operations include identifying a user account to which the authentication attempt entries correspond and locking the user account thereby preventing access thereto.

In a variety of embodiments of the computing device, the log data is network transmission log data comprised of a plurality of network transmission attempt entries, wherein each of the plurality of network transmission attempt entries originate from a first source address and includes an indicator of a transmission attempt status and a timestamp.

In a variety of embodiments of the computing device, the programmatic behavior analysis includes determining a sequence length for each of the sequential blocks. The programmatic behavior analysis further includes determining, based on the sequence length for each of the sequential blocks, whether a sequential pattern exists within the log entries that is indicative of repeated execution of a benign programmatic script. The programmatic behavior analysis further includes, responsive to a determination that no such sequential pattern exists within the log entries that is indicative of the repeated execution of the benign programmatic script, determining the log entries are indicative of anomalous behavior.

In a variety of embodiments of the computing device, the one or more automated remediation operations includes adjusting a risk score associated with the log data in a cybersecurity system.

In a variety of embodiments of the computing device, the operations further include, responsive to determining the sequential blocks of log entries were generated by repeated execution of the benign programmatic script, identifying the benign programmatic script.

In a variety of embodiments, a non-transitory computer-readable medium has stored thereon instructions that, when executed by one or more processors, cause the one or more processor to perform operations. The operations include obtaining log data comprising a plurality of log entries, wherein each log entry includes an indicator of a state of an action or resource, and a timestamp. The operations further include sorting the plurality of log entries based on the timestamps resulting in a sorted set of log entries. The operations further include identifying sequential blocks of log entries from the sorted set of log entries, wherein each sequential block of log entries includes a same status of the action or the resource, and wherein each sequential block of log entries begins with a log entry indicating a different state of the action or the resource compared to an immediately prior log entry. The operations further include performing a programmatic behavior analysis on the sequential blocks of log entries resulting in a determination as to whether the log entries were generated by repeated execution of a benign programmatic script. The operations further include, responsive to determining the sequential blocks of log entries were not generated by repeated execution of the benign programmatic script, determining the log entries indicate anomalous behavior and initiating one or more automated remediation operations.

In a variety of embodiments of the non-transitory computer-readable medium, the log data is authentication log data comprised of a plurality of authentication attempt entries, wherein each authentication attempt entry includes an authentication attempt status and a timestamp. Furthermore, the remediation operations include identifying a user account to which the authentication attempt entries correspond, and locking the user account thereby preventing access thereto.

In a variety of embodiments of the non-transitory computer-readable medium, the log data is network transmission log data comprised of a plurality of network transmission attempt entries, wherein each of the plurality of network transmission attempt entries originate from a first source address and includes an indicator of a transmission attempt status and a timestamp.

In a variety of embodiments of the non-transitory computer-readable medium, the programmatic behavior analysis includes determining a sequence length for each of the sequential blocks. The programmatic behavior analysis further includes determining, based on the sequence length for each of the sequential blocks, whether a sequential pattern exists within the log entries that is indicative of repeated execution of a benign programmatic script. The programmatic behavior analysis further includes, responsive to a determination that no such sequential pattern exists within the log entries that is indicative of the repeated execution of the benign programmatic script, determining the log entries are indicative of anomalous behavior.

In a variety of embodiments of the non-transitory computer-readable medium, the one or more automated remediation operations includes adjusting a risk score associated with the log data in a cybersecurity system.

In a variety of embodiments of the non-transitory computer-readable medium, the operations further include, responsive to determining the sequential blocks of log entries were generated by repeated execution of the benign programmatic script, identifying the benign programmatic script.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a networking environment including a sequential state pattern detection engine configured to analyze authentication logs generated by an access control point in accordance with various embodiments of the disclosure.

FIG. 2 is a conceptual illustration of a networking environment including the sequential state pattern detection engine of FIG. 1 integrated within a data intake and query system in accordance with various embodiments of the disclosure.

FIG. 3 is a logical representation of components comprising the intake system within the data intake and query system of FIG. 2 in accordance with various embodiments of the disclosure.

FIG. 4 is a flowchart illustrating a process of performing an authentication state pattern analysis by a sequential state pattern detection engine in accordance with various embodiments of the disclosure.

FIGS. 5A-5B provide a flowchart illustrating a detailed process of performing an authentication state pattern analysis by a sequential state pattern detection engine in accordance with various embodiments of the disclosure.

FIG. 6 is a conceptual illustration of a networking environment including the sequential state pattern detection engine of FIG. 1 configured to automatically perform one or more remediation operations in response to detection of a malicious attack in accordance with various embodiments of the disclosure.

FIG. 7 is a flowchart illustrating a process of performing or more remediation operations by a sequential state pattern detection engine in response to detection of a malicious attack in accordance with various embodiments of the disclosure.

FIG. 8 is a flowchart illustrating a process of performing one or more security operations by a sequential state pattern detection engine in response to detection of a benign script in accordance with various embodiments of the disclosure.

FIG. 9 is a conceptual block diagram of a device suitable for configuration with a programmatic behavior logic in accordance with various embodiments of the disclosure.

FIG. 10 is a block diagram illustrating an example computing environment that includes a data intake and query system according to an implementation of the disclosure.

FIG. 11 is a block diagram illustrating in greater detail an example of an indexing system of a data intake and query system, such as the data intake and query system of FIG. 10, according to an implementation of the disclosure.

FIG. 12 is a block diagram illustrating in greater detail an example of the search system of a data intake and query system, such as the data intake and query system of FIG. 10 according to an implementation of the disclosure.

FIG. 13 illustrates an example of a self-managed network that includes a data intake and query system according to an implementation of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate the detection of programmatic scripts. In various embodiments, devices and methods to facilitate the detection of programmatic scripts include programmatic behavior logic.

The programmatic behavior logic analyzes a series of log data to determine whether activity reflected in the log data indicates anomalous behavior. In various embodiments, the programmatic behavior logic sorts the log data in time order and separates the log data in sequential blocks. The programmatic behavior logic performs a programmatic behavior analysis on the sequential blocks to determine whether the log data indicates anomalous behavior. If the log data indicates anomalous behavior, the programmatic behavior logic initiates one or more remediation operations.

The programmatic behavior logic contributes toward the detection of anomalous behavior in a computing environment (e.g., a computing environment from which the log data is obtained). As such, the programmatic behavior logic improves cybersecurity applications by providing additional techniques to detect anomalous behavior, which can then be remediated by the cybersecurity applications. Previously, the anomalous behavior may not have been detected by existing techniques, and therefore could not be remedied. As such, when incorporated into a cybersecurity application, the programmatic behavior logic improves the cybersecurity protection provided by the cybersecurity application.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

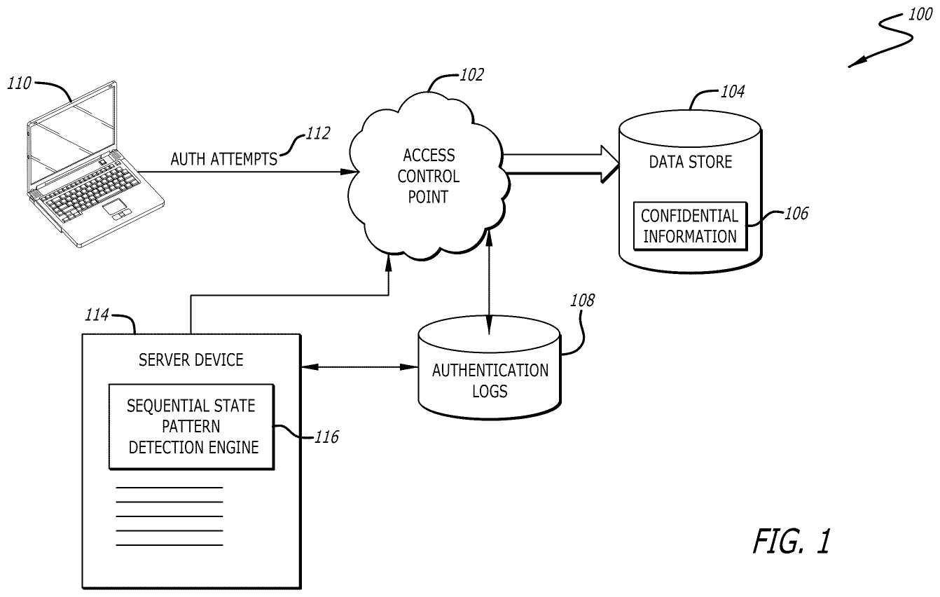

FIG. 1 is a conceptual illustration of a networking environment including a sequential state pattern detection engine 116 configured to analyze authentication logs 108 generated by an access control point 102 in accordance with various embodiments of the disclosure. The sequential state pattern detection engine 116 includes the programmatic behavior logic, which may implement some or all of the techniques described herein. The networking environment 100 includes a client device 110, the access control point 102, a data store 104, a server device 114, and authentication logs 108. In various embodiments, the services, systems, and devices of FIG. 1 are communicatively connected to one or more of each other via a network (not shown).

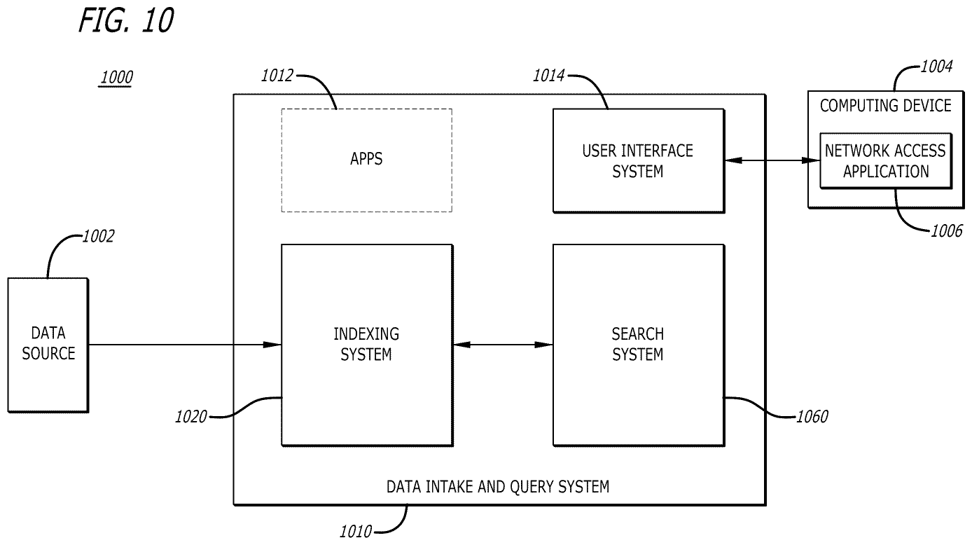

The authentication logs 108 are computer logs or other records from one or more computing devices, such as desktops, laptops, servers, network devices, smartphones, tablets, or so on. In some embodiments, the authentication logs 108 are received and/or collected from the one or more sources by a data intake and query system, such as the data intake and query system described below with reference to FIG. 10. In some embodiments, the data store 104 stores the authentication logs 108. In other embodiments, the authentication logs 108 can be stored at other data storage, such as a data storage on the server device 114. In some embodiments, the server device 114 may be part of the data intake and query system. As a particular example, the authentication logs may be WINDOWS ACTIVE DIRECTORY logs. However, a person of skill in the art will recognize that various types of logs or other data records can be used as the authentication logs 108 without departing from the principles set forth herein. In various embodiments, each authentication log 108 includes a username, an attempt status (or authentication attempt status), and a timestamp. The authentication attempt status indicates whether an authentication attempt 112 recorded by the corresponding authentication log was successful at authentication. The timestamp indicates the time at which the authentication attempt 112 was received by the access control point 102. In other embodiments, the timestamp indicates the time at which a client device 110 sent the authentication attempt 112. The username is one of the credentials included in the authentication attempt 112. In some embodiments, the authentication logs 108 do not include usernames.

The data store 104 is a data storage solution, such as a relational or non-relational database, data lake, or so on. The data store 104 hosts confidential information 106 that a malicious actor may desire to access. The data store 104 secures the confidential information 106 using one or more cybersecurity techniques, such as restricting access to the confidential information 106 only to certain users, who must verify their credentials (e.g., username and password) before access is granted. Access to the data store 104 may be controlled partially or wholly by the access control point 102.

The access control point 102 is a secure portal that provides access to the data store 104, e.g., by hosting a role-based access control service. The access control point 102 may be implemented at a tenant space on a cloud platform, such as the tenant space of an organization associated with the data store 104. In some embodiments, the access control point 102 includes a server device, network device, or other computing device. For example, the access control point 102 may include a router, such as a CISCO INTEGRATED SERVICES ROUTER. The access control point 102 receives one or more authentication attempts 112 from client devices 110 and determines whether to grant access to the respective client devices 110 based on the content of the authentication attempts 112. For example, each authentication attempt 112 may include a username and password. The access control point 102 evaluates the username and password. Based on the evaluation, the access control point 102 either grants access to the client device 110 that sent the authentication attempt 112 or denies access. Some or all authentication attempts 112 are recorded as authentication logs 108, e.g., by the access control point 102. For example, the access control point 102 may receive authentication attempt 112 at time T1. The access control point 102 may generate and/or store an authentication log 108 corresponding to the authentication attempt 112.

The client device 110 is a computing device, such as a desktop or laptop, a smartphone or tablet, a server, or other computing device. The client device 110 sends one or more authentication attempts 112 to the access control point 102, e.g., to access the data store 104. When granted access, the client device 110 can access the confidential information 106. Although the embodiment of the figure includes one client device 110, the networking environment 100 can include fewer, other or additional devices than those illustrated, such as multiple client devices 110. In various embodiments, one or more client devices 110 are those of malicious actors, who may use their client devices 110 for malicious purposes, such as to conduct brute force attacks against the data store 104 by way of the access control point 102 in attempts to improperly access the confidential information 106. As noted here, malicious actors may conduct intelligent brute force attacks to avoid triggering an account lock-out mechanism that seeks to prevent traditional brute force attacks by locking a user account after a predetermined number of failed password attempts within a given time period.

The server device 114 is a server computer. In other embodiments, the server device 114 may be a tenant space on a cloud platform, a personal computer, such as a laptop or desktop, or any other suitable computing device. The server device 114 is communicatively connected to the access control point 102 and obtains some or all authentication logs 108 of the access control point 102. The server device 114 hosts the sequential state pattern detection engine 116. The sequential state pattern detection engine 116 analyzes a series of log data, such as the authentication logs 108, to determine whether activity reflected in the log data indicates the behavior of a benign programmatic script. For example, the sequential state pattern detection engine 116 may obtain authentication logs 108 corresponding to a set of authentication attempts 112 and determine whether the client device 110 is executing a benign programmatic script based on the obtained authentication logs 108. The various techniques which may be implemented by the sequential state pattern detection engine 116 are described in further detail below.

In some implementations, the log data may be network transmission log data comprised of a plurality of network transmission attempt entries, wherein each of the plurality of network transmission attempt entries originate from a first source address (IP address) and includes an indicator of a transmission attempt status and a timestamp.

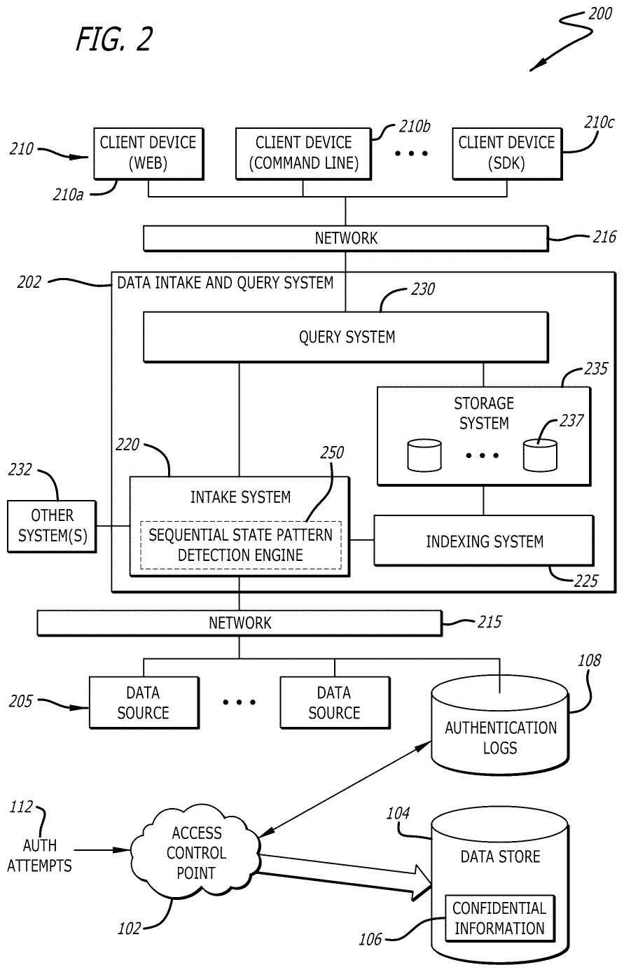

FIG. 2 is a conceptual illustration of a networking environment 200 including the sequential state pattern detection engine of FIG. 1 integrated within a data intake and query system 202 in accordance with various embodiments of the disclosure. The data processing environment 200 features one or more data sources 205 (generically referred to as “data source(s)”) and client devices 210a, 210b, 210c (generically referred to as “client device(s) 210”) in communication with the data intake and query system 202 via networks 215 and 216, respectively. The networks 215 & 216 may correspond to portions of the same network or may correspond to different networks. Further, the networks 215 & 216 may be implemented as private and/or public networks, one or more LANs, WANs, cellular networks, intranetworks, and/or internetworks using any of wired, wireless, terrestrial microwave, satellite links, etc., and may include the Internet.

Each data source 205 broadly represents a distinct source of data that can be consumed by the data intake and query system 202. The data source(s) 205 may be positioned within the same geographic area or within different geographic areas such as different regions of a public cloud network. Examples of a data source 205 may include, without limitation or restriction, data files, directories of files, data sent over a network, event logs, registries, streaming data services, etc. In various embodiments, the authentication logs 108 are or come from a data source 205, e.g., the data intake and query system 202 receives the authentication logs 108 from one or more devices over the network 215.

The client device(s) 210 can be implemented using one or more computing devices in communication with the data intake and query system 202, and represent some of the different ways in which computing devices can submit queries to the data intake and query system 202. For example, a first client device 210a may be configured to communicate with the data intake and query system 202 over the network 216 via an Internet (Web) portal. In contrast, a second client device 210b may be configured to communicate with the data intake and query system 202 via a command line interface while a third client device 210c may be configured to communicate with the data intake and query system 202 via a software developer kit (SDK). As illustrated, the client device(s) 210 can communicate with and submit queries to the data intake and query system 202 in accordance with a plurality of different communication schemes. In various embodiments, a particular client device 210 may be the client device 110 of FIG. 1.

The data intake and query system 202 can process and store data received from the data source(s) 205 and execute queries on the data in response to requests received from the client device(s) 210. In the illustrated embodiment, the data intake and query system 202 includes an intake system 220, an indexing system 225, a query system 230, and/or storage system 235 including one or more data stores 237. The intake system 220 includes the sequential state pattern detection engine 250. In other embodiments, another system of the data intake and query system 202 includes the sequential state pattern detection engine 250, or a system connected to the data intake and query system 202, such as a behavioral analytics service of a cybersecurity application built on the data intake and query system 202. The data intake and query system 202 may include systems, subsystems, and components, other than the systems 220/225/230/235 described herein. Some of these other systems, subsystems and components are described in U.S. Patent Publication No. 2021/0117857, the entire contents of which are incorporated by reference herein. In some embodiments, the data store 104 with confidential information 106 can be part of the storage system 235. In other embodiments, the data store 104 is remote from the data intake and query system 202. For example, the data store 104 may be hosted by a hyperscaler (e.g., a large-scale cloud service provider) accessible by the data intake and query system 202 through an other system 232.

In various embodiments, the access control point 102 is part of the data intake and query system 202. In other embodiments, the access control point 102 is separate from the data intake and query system 202, but may correspond to a same organization as the data intake and query system 202. For example, both the access control point 102 and data intake and query system 202 may be part of a computing environment of a particular organization. In some embodiments, the access control point 102 enforces access control to the data intake and query system 202. In various embodiments, authentication attempts 112 received by the access control point 102 (e.g., via a client device 210) are logged by the access control point 102 as authentication logs 108, which are ingested by the data intake and query system 202. In such embodiments, the access control point 102 may be a data source 205 of the data intake and query system 202.

As mentioned, the data intake and query system 202 can receive or subsequently store (ingest) data from different sources 205. In some cases, the data sources 205 can be associated with different tenants or customers. Further, each tenant may be associated with one or more indexes, hosts, sources, sourcetypes, or users. The data intake and query system 202 can concurrently receive and process the data from multiple tenants, namely systems and sources owned or controlled by these tenants. In certain cases, although the data from different tenants can be processed together or concurrently, the data intake and query system 202 can take steps to avoid combining or co-mingling data from the different tenants. For example, the data intake and query system 202 can assign a tenant identifier for each tenant and maintain separation between ingested data using the tenant identifier. In some cases, the tenant identifier can be assigned to the data at the data sources 205, or can be assigned to the data by the data intake and query system 202 at time of ingestion.

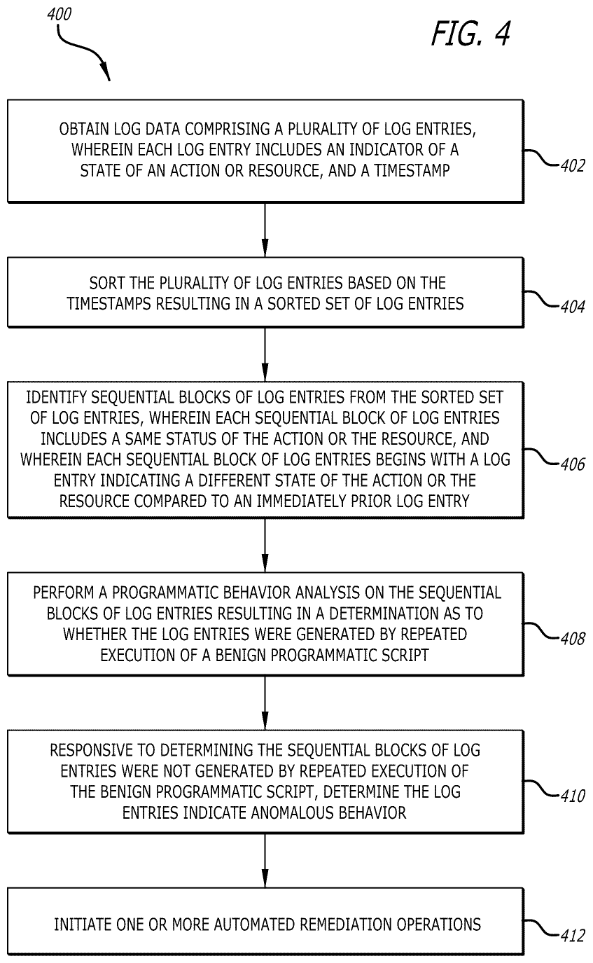

As will be described in greater detail herein, as illustrated in FIG. 4, the intake system 220 may be configured to (i) receive data from the data sources 205, (ii) perform one or more preliminary processing operations on the data, and/or (iii) communicate the data to the indexing system 225, query system 230, or to other systems 232 (which may include, for example, data processing systems, telemetry systems, real-time analytics systems, data stores, databases, etc., any of which may be operated by an operator of the data intake and query system 202 or a third party).

In particular, the intake system 220 may be configured to receive data from the data source(s) 205 in a variety of formats or structures. In some embodiments, the received data may correspond to raw machine data, structured or unstructured data, correlation data, data files, directories of files, data sent over a network, event logs, registries, messages published to streaming data sources, performance metrics, sensor data, image and/or video data, etc. The intake system 220 can process the data based on the form in which it is received. In some cases, the intake system 220 can utilize one or more rules to process the data and to make the processed data available to downstream systems (e.g., the indexing system 225, query system 230, etc.).

The intake system 220 can enrich the received data. For example, the intake system 220 may add one or more fields to the data received from the data sources 205, such as fields denoting the host, source, sourcetype, index, or tenant associated with the incoming data. In certain embodiments, the intake system 220 can perform additional processing on the data, such as transforming structured data into unstructured data (or vice versa), identifying timestamps associated with the data, removing extraneous data, parsing data, indexing data, separating data, categorizing data, routing data based on criteria relating to the data being routed, and/or performing other data transformations, etc. As described herein, the intake system 220 can perform data ingestion anomaly detection and reporting of detected anomalies, such as the detection of anomalous behavior when the sequential state pattern detection engine 250 determines a pattern of behavior determined from authentication logs 108 does not indicate a benign programmatic script.

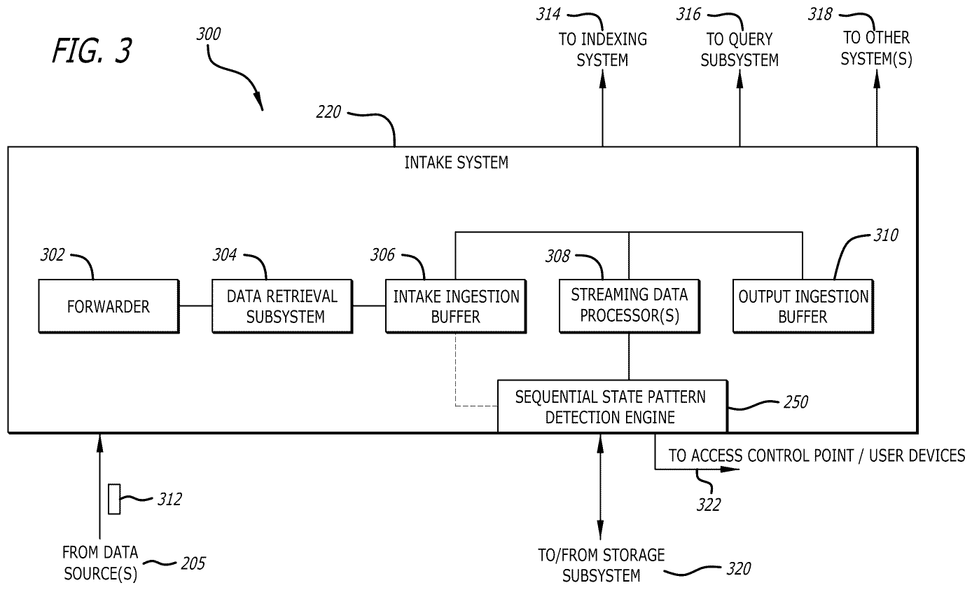

FIG. 3 is a logical representation 300 of components comprising the intake system 220 within the data intake and query system 202 of FIG. 2 in accordance with various embodiments of the disclosure. In various embodiments, the intake system 220 features one or more streaming data processors 308 for processing, where the streaming data processor(s) 308 can be configured with one or more data transformation rules to transform incoming messages, and republish the messages to one or both of an intake ingestion buffer 306 and an output ingestion buffer 310. In particular, the intake system 220 can function to conduct preliminary processing of data 312 ingested at the data intake and query system 202. As such, the intake system 220 can include a forwarder 302 that obtains data 312 from one of the data source(s) 205 and transmits the data 312 to a data retrieval subsystem 304.

The data retrieval subsystem 304 may be configured to convert or otherwise format data 312 provided by the forwarder 302 into an appropriate format for inclusion at an intake ingestion buffer 306 and transmit the message to the intake ingestion buffer 306 for processing. Thereafter, the streaming data processor(s) 308 may obtain data 312 from the intake ingestion buffer 306, process the data according to one or more rules, and republish the data to either the intake ingestion buffer 306 (e.g., for additional processing) or to the output ingestion buffer 310, such that the data 312 is made available to downstream components or subsystems such as the indexing system 225, query system 230 or other systems 232. In this manner, the intake system 220 may repeatedly or iteratively process data 312, such as authentication logs 108, according to any of a variety of rules, such that the data is formatted for use on the data intake and query system 202 or any other system. As discussed below, the intake system 220 may be configured to conduct such processing rapidly (e.g., in “real-time” with little or no perceptible delay), while ensuring resiliency of the data.

In various embodiments, the sequential state pattern detection engine 250 is configured to analyze data from the intake ingestion buffer 306 to identify anomalies, such as patterns of behavior that do not match benign programmatic scripts. When a component of the intake system 220, the sequential state pattern detection engine 250 may include a communicative coupling 322 to the access control point. Alternatively, the sequential state pattern detection 250 may analyze authentication logs 108 after they have been ingested and processed by the intake system 220 as data 312. In various embodiments, the sequential state pattern detection engine 250 is not part of the intake system 220. For example, the sequential state pattern detection engine 250 may be part of a security information and event management (SIEM) application, such as a SIEM application built on top of the data intake and query system 202. In such embodiments, the SIEM application receives data 312, such as processed authentication logs 108, from the data intake and query system 202, some or all of which is input to the sequential state pattern detection engine 250. The sequential state pattern detection engine 250 determines whether the data 312 indicates a benign programmatic script, and if not, initiates one or more remediation operations.

In various embodiments, the sequential state pattern detection engine 250 is part of a cybersecurity system connected to a SIEM application, such as a behavioral analytics system that processes data 312 from the data intake and query system 202 and sends identified anomalies and/or related information to the SIEM application. As a particular example, the data intake and query system 202 may be SPLUNK ENTERPRISE, the SIEM application may be SPLUNK ENTERPRISE SECURITY, and the behavioral analytics system that implements the sequential state pattern detection engine 250 may be SPLUNK USER BEHAVIOR ANALYTICS.

FIG. 4 is a flowchart illustrating a process 400 of performing a sequential state pattern detection by a sequential state pattern detection engine in accordance with various embodiments of the disclosure. The sequential state pattern detection engine obtains 402 log data. The log data includes a plurality of log entries. Each log entry includes an indicator of a state of an action or resource, and a timestamp. For example, the authentication log data can be raw authentication logs received from an access control point, or can be events generated by a data intake and query system based on authentication logs received from a data source (such as the access control point). The authentication log data represents the authentication attempt entries, and in various embodiments includes some or all of the authentication attempt entries. In various embodiments, the timestamp indicates a time at which the data intake and query system received or processed the respective authentication log.

Although described henceforth with reference to authentication attempt entries, a person of skill in the art will recognize that other types of data can be employed by the described process without deviating from the principles set forth herein. Furthermore, in various embodiments, the process can include more, fewer, or other steps, and one or more steps may be performed in different orders than as described herein.

The sequential state pattern detection engine sorts 404 the plurality of log entries based on the timestamps resulting in a sorted set of log entries. In various embodiments, the sequential state pattern detection engine sorts 404 the authentication attempt entries in ascending temporal order, with an authentication attempt entry corresponding to an oldest timestamp sorted into a first position and an authentication attempt entry corresponding to a most recent timestamp sorted into a last position.

The sequential state pattern detection engine identifies 406 sequential blocks of log entries from the sorted set of log entries. Each sequential block of log entries includes a same status of the action or the resource. Furthermore, each sequential block of log entries begins with a log entry indicating a different state of the action or the resource compared to an immediately prior log entry (or is the first log entry in the sorted set of log entries). For example, the sorted set of log entries may include log entries “A, B, C, d, E, F, G, h, I, J, K” where an uppercase letter indicates the respective log entry has a first state for the state of the action or resource, and a lowercase letter indicates the respective log entry has a second state for the state of the action or resource. The five identified 406 sequential blocks of log entries in this example would be ABC, d, EFG, h, IJK.

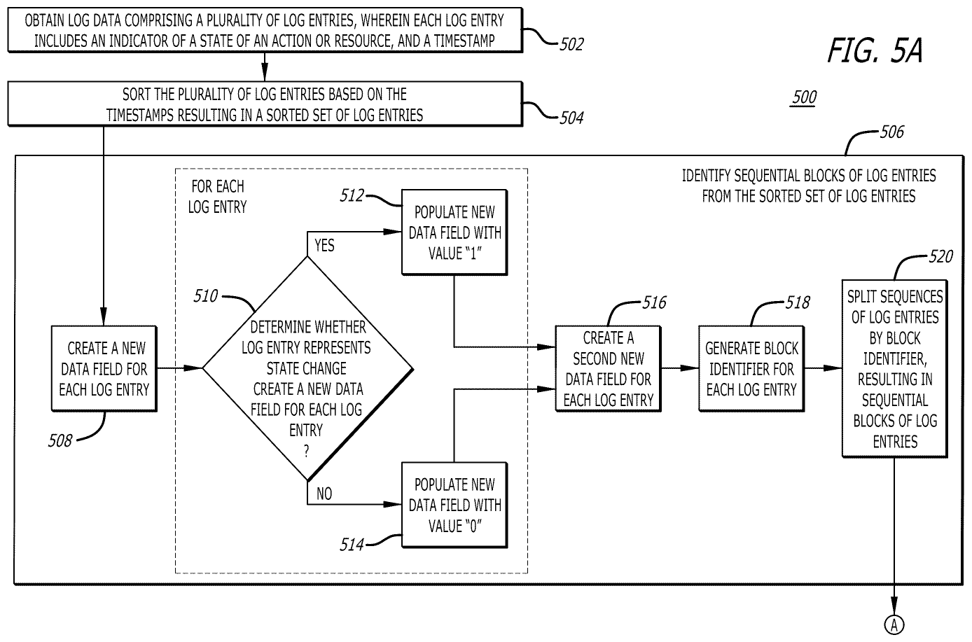

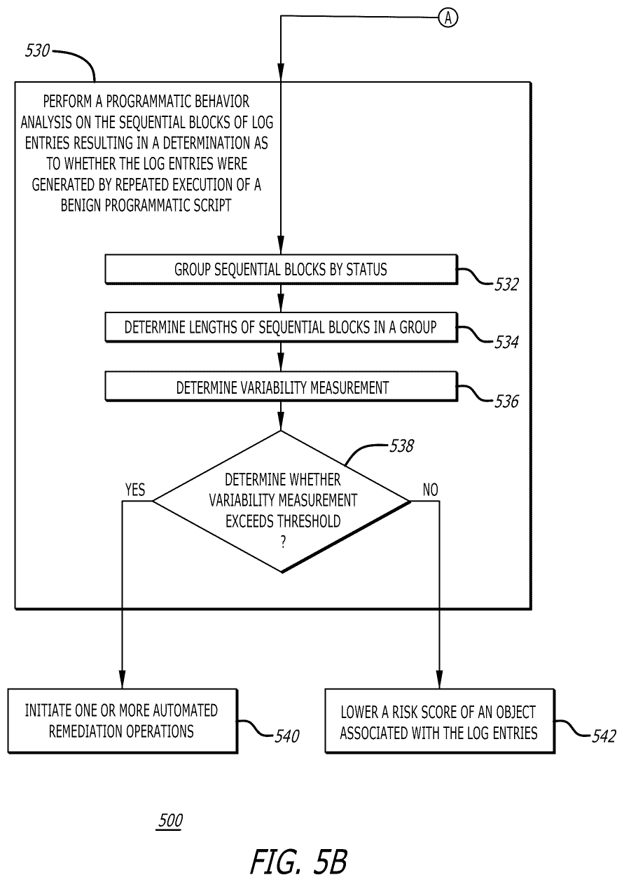

The sequential state pattern detection engine performs 408 a programmatic behavior analysis on the sequential blocks of log entries. The programmatic behavior analysis results in a determination as to whether the log entries were generated by repeated execution of a benign programmatic script. Details of the programmatic behavior analysis are further described with reference to FIGS. 5A-5B below.

The sequential state pattern detection engine, responsive to determining the sequential blocks of log entries were not generated by repeated execution of a benign programmatic script, determines 410 the log entries indicate anomalous behavior and initiates 412 one or more automated remediation operations. In alternative embodiments, the sequential state pattern detection engine determines the sequential blocks of log entries were generated by repeated execution of a benign programmatic script, and does not initiate one or more automated remediation operations. Details of performing the one or more automated remediation options are further described below.

FIGS. 5A-5B provide a flowchart illustrating a detailed process 500 of performing a sequential state pattern detection by a sequential state pattern detection engine in accordance with various embodiments of the disclosure. The sequential state pattern detection engine analyzes a series of log data to determine whether activity reflected in the log data indicates anomalous behavior. The sequential state pattern detection engine obtains 502 log data. The log data includes a plurality of log entries. Each log entry includes an indicator of a state of an action or resource, and a timestamp. For example, the authentication log data can be raw authentication logs received from an access control point, or can be events generated by a data intake and query system based on authentication logs received from a data source (such as the access control point). The authentication log data represents the authentication attempt entries, and in various embodiments includes some or all of the authentication attempt entries. In various embodiments, the timestamp indicates a time at which the data intake and query system received or processed the respective authentication log.

Although described henceforth with reference to log entries, a person of skill in the art will recognize that other types of data can be employed by the described process without deviating from the principles set forth herein. Furthermore, in various embodiments, the process can include more, fewer, or other steps, and one or more steps may be performed in different orders than as described herein.

The sequential state pattern detection engine sorts 504 the plurality of log entries based on the timestamps resulting in a sorted set of log entries. In various embodiments, the sequential state pattern detection engine sorts 504 the authentication attempt entries in ascending temporal order, with an authentication attempt entry corresponding to an oldest timestamp sorted into a first position and an authentication attempt entry corresponding to a most recent timestamp sorted into a last position.

The sequential state pattern detection engine identifies 506 sequential blocks of log entries from the sorted set of log entries. Each sequential block of log entries includes a same status of the action or the resource. Furthermore, each sequential block of log entries begins with a log entry indicating a different state of the action or the resource compared to an immediately prior log entry (or is the first log entry in the sorted set of log entries). For example, the sorted set of log entries may include log entries “A, B, C, d, E, F, G, h, I, J, K” where an uppercase letter indicates the respective log entry has a first state for the state of the action or resource, and a lowercase letter indicates the respective log entry has a second state for the state of the action or resource. The five identified 406 sequential blocks of log entries in this example would be ABC, d, EFG, h, IJK. As another example, one sequential block may end and another may begin where one log reflects a “Success” status and a next log reflects a “Failure” status (such as a “login attempt” status) or vice versa. For example, a set of eight successive of log entries each indicating a failed login status “F” or a successful login status “S” may be separated into blocks that may be conceptualized as FFF, S, FFF, S. In various embodiments, identifying 506 the sequential blocks is part of the programmatic behavior analysis described below.

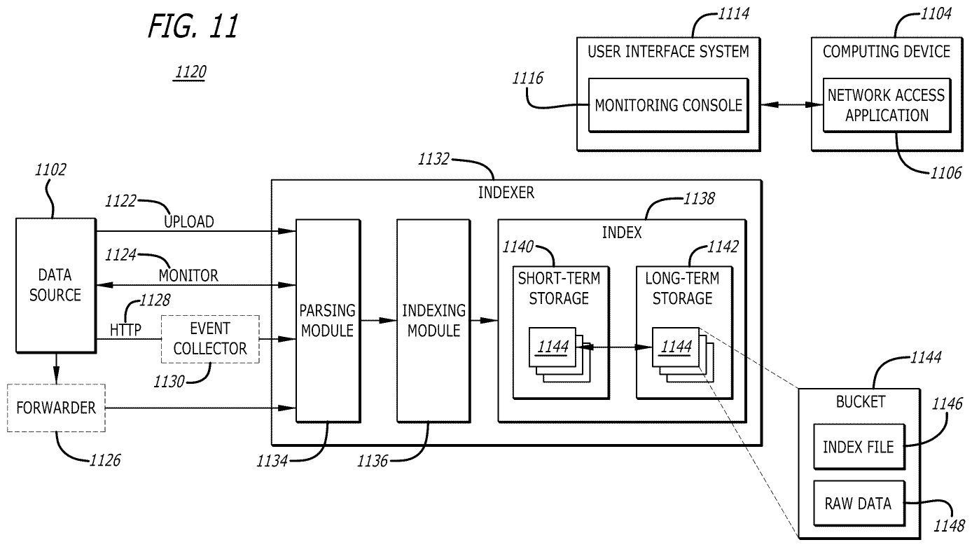

In various embodiments, the sequential state pattern detection engine identifies 506 these sequential blocks by creating 508 a new data field for each log entry in the sorted set of log entries. In some embodiments, this may be done within a data frame, such as a data frame that comprises part of a user interface of a cybersecurity application, and the log entries may be part of one or more events, as described below with reference to FIG. 11. In such embodiments, the new data field may be a new column in the data frame. The sequential state pattern detection engine determines 510 whether each log entry in the sorted set represents a change in the state of the action or resource indicated by the log entry. Each instance of the new data field is populated by the sequential state pattern detection engine according to whether the corresponding log entry represents a change in the state of an action or resource indicated by the log entry, as compared to an immediately preceding log entry in the sorted set. If the corresponding log entry indicates a state change (or is the temporally first log in the log data), the sequential state pattern detection engine sets 512 the respective new data field to “1,” and otherwise sets 514 the respective new data field to “0.” Returning to the example above, eight successive logs may produce a series of statuses FFFSFFFS. The sequential state pattern detection engine would populate the respective new data fields as 10011001.

In various embodiments, the sequential state pattern detection engine then creates 516 a second new data field for each log entry. Alternatively, the sequential state pattern detection engine may reuse the existing new data field and overwrite the existing new data fields with block identifiers. In either case, the sequential state pattern detection engine generates 518 a block identifier for each log entry by summing the values of the existing new data field for all log entries in the sorted set preceding and including the log entry. Returning to the example above, the first log entry has a block identifier “1,” the second log entry has a block identifier determined by 1+0 which is 1, and the third log entry has a block identifier determined by 1+0+0 which is 1. The fourth log entry changes status, which is reflected in its block identifier, which is determined by 1+0+0+1, which is 2. After evaluation for each log entry, the example series of log data produces block identifiers in a series of “11123334.”

In various embodiments, the sequential state pattern detection engine then creates the sequential blocks according to the block identifiers, e.g., by splitting 520 sequences of log entries by block identifier and making each split group of log entries a sequential block. Returning to the above example, the first three log entries, which each have block identifier 1, form a first sequential block (representing three failures in a row). The fourth log entry, which has block identifier 2, forms a second sequential block (representing one success). The fifth, sixth, and seventh log entries, which each have block identifier 3, form a third sequential block (representing three failures in a row). The eighth log entry, which has block identifier 4, forms a fourth sequential block (representing one success).

The sequential state pattern detection engine performs 530 a programmatic behavior analysis to determine whether the log entries represent anomalous behavior (e.g., whether the log entries represent benign or malicious behavior). The programmatic behavior analysis can include analyzing the sequential blocks, as follows. The sequential state pattern detection engine groups 532 the sequential blocks by status. Then, for one or more groups of sequential blocks, e.g., for sequential blocks corresponding to failures, the sequential state pattern detection engine determines 534 a length of each sequential block (sequence length) in the group. Based on the determined lengths, the sequential state pattern detection engine determines 536 a variability measurement, with one example being a coefficient of variation. The sequential state pattern detection engine determines 538 whether the variability measurement meets or exceeds a threshold. When the variability measurement meets or exceeds the threshold, the sequential state pattern detection engine determines the activity reflected in the log entries to be indicative of anomalous behavior. When the variability measurement does not meet the threshold, the sequential state pattern detection engine determines the activity reflected in the log entries to be indicative of a benign programmatic script.

Conceptually, when the variability measurement is below the threshold, the variation in the lengths of the sequential blocks in the group (e.g., the group of sequential blocks corresponding to a “failure” status) is small. In various embodiments, the threshold may be small, such as a coefficient of variation of 0.05%. If the sequential blocks in a group represent log entries indicating failed authentication attempts, and each sequence of authentication failures is the same number of authentication failures, this can indicate the authentication attempts were initiated by a programmatic script. Specifically, repeated sequences (sequential pattern) of the same number of failed authentication attempts can indicate benign programmatic scripts. This can be because log entries representing the behavior of malicious scripts will typically display more sophisticated patterns of authentication attempts, or at least less repetitive sequences of a certain number of failures followed by a successful authentication (which can indicate a benign programmatic script failed, at which point a benign user authenticated manually). As such, minimal variation (e.g., variance) can indicate a benign programmatic script, and not having minimal variation can indicate anomalous behavior, such as malicious behavior, that potentially should be investigated, and/or should initiate one or more automated remediation operations.

The sequential state pattern detection engine, responsive to determining the sequential blocks of log entries were not generated by repeated execution of a benign programmatic script (e.g., that no such sequential pattern exists), initiates 540 one or more automated remediation operations. Details of performing the one or more automated remediation options are further described below. In alternative embodiments, the sequential state pattern detection engine determines the sequential blocks of log entries were generated by repeated execution of a benign programmatic script, and does not initiate one or more automated remediation operations. Rather, the sequential state pattern detection engine may lower 542 a risk score of an object associated with the log entries, e.g., an object represented in a cybersecurity application, such as a SIEM application.

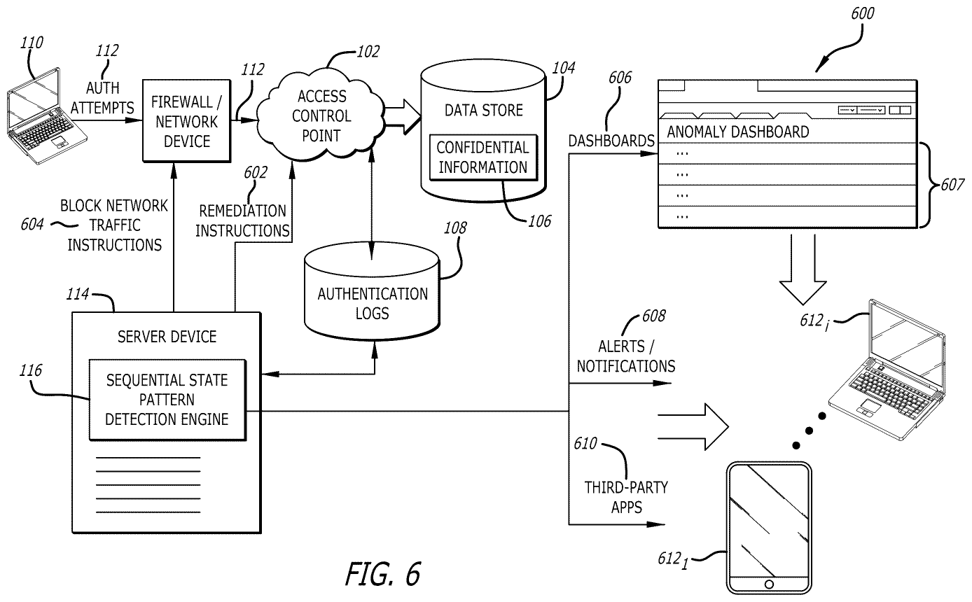

FIG. 6 is a conceptual illustration of a networking environment 600 including the sequential state pattern detection engine of FIG. 1 configured to automatically perform one or more remediation operations in response to detection of a malicious attack in accordance with various embodiments of the disclosure. The client device 110 sends authentication attempts 112 to the access control point 102. Before reaching the access control point 102, the authentication attempts may pass through a firewall 112, which may be at a network device of an organization associated with the data store 104 including confidential information 106, or may be part of a tenant space of the organization on a cloud infrastructure. As described above, the server device 114 receives authentication logs 108 representing the authentication attempts 112, e.g., from a data intake and query system of the organization that has as a data source the access control point 102. In some embodiments, the server device 114 receives the authentication logs 108 directly from the access control point 102.

The server device 114 executes the sequential state pattern detection engine 116. In embodiments where the sequential state pattern detection engine 116 determines that the authentication attempts 112 indicate an anomalous behavioral pattern, the sequential state pattern detection engine 116 performs one or more remediation actions. In some embodiments, the one or more remediation actions include blocking network traffic from the client device 110, e.g., blocking an IP address associated with the client device 110. The sequential state pattern detection engine 116 sends block network traffic instructions 604 to the firewall 112. The firewall blocks network traffic accordingly. As such, the sequential state pattern detection engine can remediate malicious activity by blocking the source of the activity from making further authentication attempts 112.

In various embodiments, the one or more remediation actions include sending remediation instructions 602 to the access control point 102 and/or one or more third-party applications 612₁₋ᵢ, such as a cybersecurity application. The remediation instructions 602 can include temporarily quarantining one or more user accounts, such as those associated with usernames included in the authentication attempts; changing one or more access permissions to the data store 104; temporarily freezing access to the data store 104; identifying whether the client device 110 accessed the data store 104, and if so, determining whether any confidential information 106 was accessed; sending an alert to an administrator of the access control point 102; updating one or more network settings and/or one or more firewall settings; and/or implementing a higher security role-based access control policy, temporarily or permanently.

In various embodiments, the one or more remediation actions include sending an anomaly detection alert 608 to a SIEM application, a security orchestration, automation and response (SOAR) application, and/or a user such as a security operations center (SOC) analyst via one or more network devices 612. In various embodiments, the sequential state pattern detection engine generates dashboards 606, which may be sent to one or more destinations, such as the SIEM application. In other embodiments, the SIEM application generates or updates a dashboard 606 based on data received from the sequential state pattern detection engine 116, e.g., data included in the anomaly detection alert. Dashboards are described in further detail below, e.g., with reference to FIG. 10. The dashboard 606 presents anomaly information, such as indicators of anomalous activity, such as malicious activity, and can include a listing 607 of anomalous behavior and/or anomalous objects in the networking environment 600. Dashboards 606 may be provided to a user such as a SOC analyst via the one or more network devices 612.

In some instances, such as following a determination that a set of authorization logs is suspicious or malicious, such may be emphasized in the listing 607 (e.g., prioritized at the top of the listing 607, provided in a bold or colored manner, provided with a flag, etc.), an alert/notification 608 may be generated by the SIEM application and provided to a user such as a SOC analyst via the one or more network devices 612, and/or the SIEM application may generate remedial instructions that are provided to third-party apps 610 (e.g., MICROSOFT OUTLOOK®). Anomalies, and/or object associated with anomalous behavior, that are represented in the listing 607 may each be associated with a respective risk score that quantifies an estimated risk of the respective anomaly. The risk scores may be based on various detection engines producing risk score adjustments, which cumulatively generate an overall risk score. In some embodiments, the sequential state pattern detection engine 116 generates a risk score adjustment, and/or the SIEM application uses data received from the sequential state pattern detection engine 116 to adjust a risk score, of an entry in the listing 607 associated with the authorization attempts 112, e.g., an entry representing the client device 110.

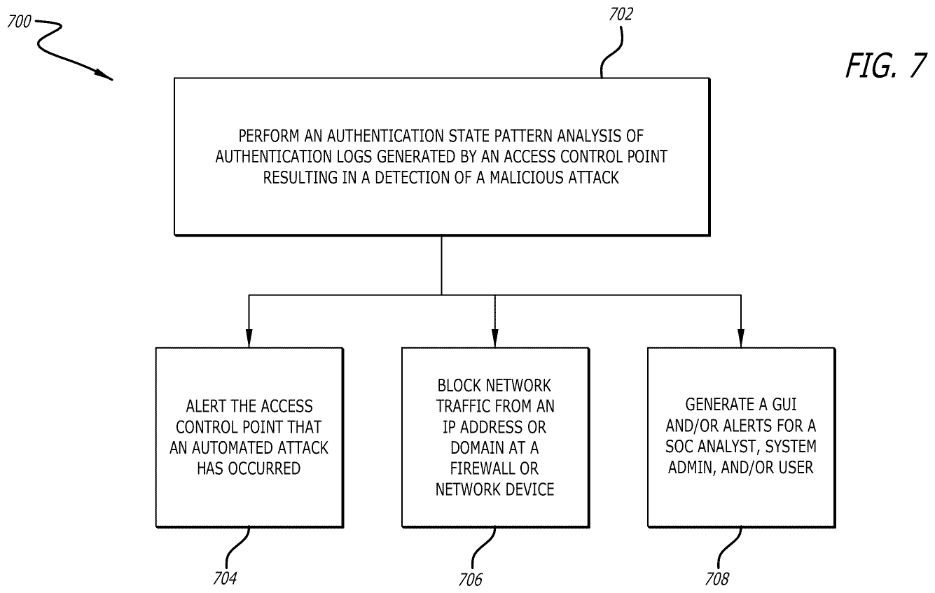

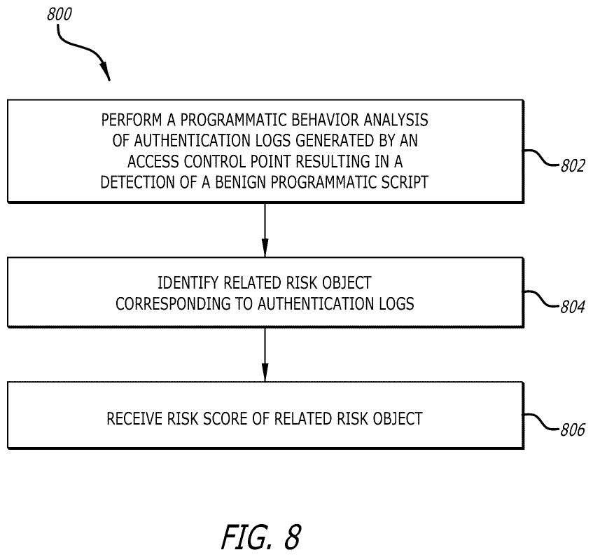

The remedial instructions may cause specific, automated remedial actions, such as blocking an IP address. In some cases, the SIEM application triggers a SOAR application to perform one or more automated remedial actions. In some embodiments, when a risk score exceeds a certain score value, and/or when a particular behavior is detected, such as an anomalous behavior pattern in authentication attempts, the SIEM triggers the SOAR to initiate one or more remedial operations, such as some or all of those described herein. Thus, the remedial instructions improve the processing of a computer by automatically taking remedial action. Various remedial actions that can be initiated based on results of the sequential state pattern detection engine are described below with reference to FIG. 7-8.

FIG. 7 is a flowchart illustrating a process 700 of performing or more remediation operations by a sequential state pattern detection engine in response to detection of a malicious attack in accordance with various embodiments of the disclosure. The sequential state pattern detection engine performs 702 a programmatic behavior analysis of authentication logs generated by an access control point, resulting in a detection of a malicious attack. The sequential state pattern detection engine then performs one or more remediation operations, such as one or more of remedial operations 704, 706, 708. In some embodiments, the sequential state pattern detection engine alerts 704 the access control point that a malicious attack has occurred. In some embodiments, the sequential state pattern detection engine blocks 706 network traffic from an IP address or domain at a firewall or network device. In some embodiments, the sequential state pattern detection engine generates 708 a graphical user interface (GUI) and/or one or more alerts, e.g., alerts for a SOC analyst, system administrator, and/or user of the system. In some embodiments, the sequential state pattern detection engine performs one or more remediation operations described with reference to FIG. 6.

FIG. 8 is a flowchart illustrating a process 800 of performing one or more security operations by a sequential state pattern detection engine in response to detection of a benign script in accordance with various embodiments of the disclosure. The sequential state pattern detection engine performs 802 a programmatic behavior analysis of authentication logs generated by an access control point, resulting in a detection of a benign programmatic script. The sequential state pattern detection engine identifies 804 a related risk object that corresponds to the authentication logs, e.g., a risk object in a SIEM application that represents the client device 110 that sent the authorization attempts which resulted in the authentication logs. The sequential state pattern detection engine reduces 806 a risk score of the related risk object. In various embodiments, the risk score of the related risk object is a combination of various component risk scores generated by various detection engines, e.g., detection engines in the SIEM application and/or detection engines in cybersecurity applications connected to the SIEM application. Due to the programmatic behavior analysis indicating a benign programmatic script, the sequential state pattern detection engine sends an adjustment to the risk score of the related risk object to the SIEM application. As such, in a listing, e.g., listing 607, the related risk object may be reranked, e.g., moved further down the listing 607. By moving reducing the risk scores of risk objects associated with benign programmatic scripts, the sequential state pattern detection engine contributes to a reduction in the investigation of anomalous behaviors that are false positives for malicious activity (e.g., by moving the risk object lower in the listing 607, or otherwise adjusting its representation to indicate it is less in need of investigation and/or remediation).

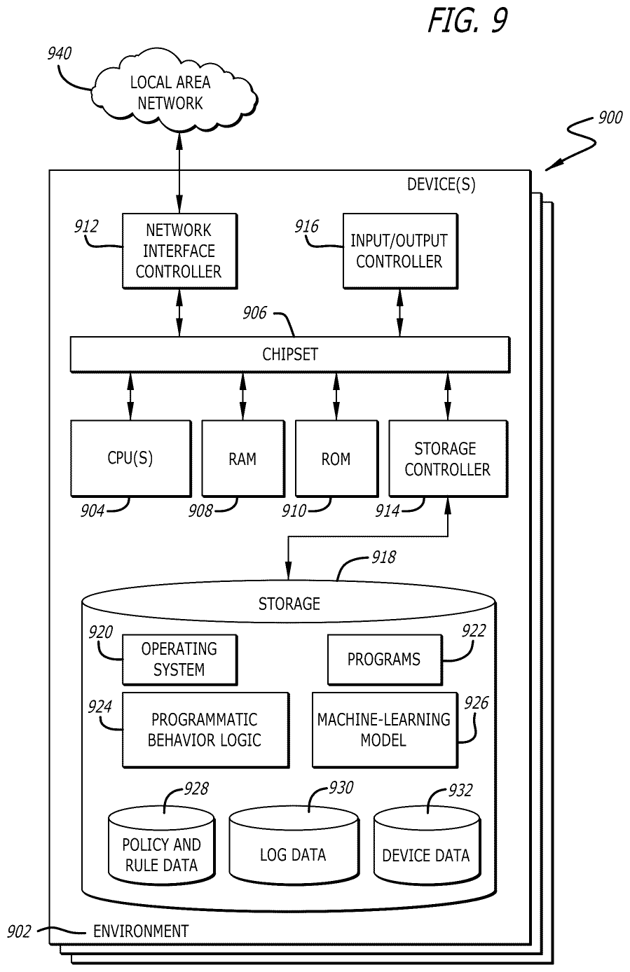

FIG. 9 is a conceptual block diagram of a device 900 suitable for configuration with a programmatic behavior logic in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many nonlimiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, programs 922, policy and rule data 928, log data 930, and device data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer executable instructions may be stored as program 922 (for example, an application) and transform the device 900 by specifying how the processor(s) 904 can transition between states, as described above. In some embodiments, the device 900 has access to computer-readable storage media storing computer executable instructions which, when executed by the device 900, perform the various processes described above. In certain embodiments, the device 900 can also include computer-readable storage media having instructions stored thereupon for performing any of the other computer-implemented methods and operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many further embodiments, the device 900 may include a programmatic behavior logic 924. The programmatic behavior logic 924 can be configured to perform one or more of the various steps, processes, operations, and/or other methods that are described above. Often, the programmatic behavior logic 924 can be a set of instructions stored within a non-volatile memory that, when executed by the processor(s) 904 can carry out these steps, etc. In numerous embodiments, the programmatic behavior logic 924 may perform various operations related to detecting programmatic scripts and responding to those programmatic scripts or to anomalous behavior determined not to be resultant from a programmatic script, as described in various embodiments throughout the present disclosure.

In various embodiments, the storage 918 can include the policy and rule data 928. The policy and rule data 928 may refer to sets of guidelines and conditions that govern how sessions and communication activities are managed within a network. The policy data can define overarching principles or objectives, such as business goals, while rule data may contain the specific instructions or criteria that dictate how session activities are to be routed. Together, the policy and rule data 928 may ensure that network operations align with performance requirements, enabling dynamic and intelligent session routing decisions based on real-time device metrics.

In still more embodiments, the storage 918 can include the log data 930. The log data 930 may include records generated by one or more computer systems, devices, or applications that capture events, transactions, or status updates over time. These records typically include timestamps, event types, source identifiers, and detailed information about system activities or user interactions. Log data can be used for any of a variety of purposes, such as monitoring system performance, detecting anomalies, ensuring security compliance, performing forensic analysis, and so on. Log data is commonly stored in structured or semi-structured formats, enabling efficient indexing, retrieval, and analysis.

In a number of embodiments, the storage 918 can include device data 932. The device data 932 may refer to the detailed information and metrics about the network devices involved in communication and session routing. The device data 932 includes various attributes such as device type (e.g., server, edge device, or gateway), location, current load or utilization, processing capacity, operational status (online/offline), and power consumption. The device data 932 also includes connectivity characteristics like bandwidth, latency, and network type (e.g., 4G, 5G, Wi-Fi). The programmatic behavior logic 924 may utilize the device data 932 to make informed decisions regarding cybersecurity operations, among other use cases.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the policy and rule data 928, the log data 930, and the device data 932, and utilize the learning to predict future outcomes. For example, the ML model(s) 926 can be utilized for identifying programmatic scripts using supervised learning techniques like linear regression or random forests. Unsupervised learning methods, such as k-means clustering, can detect hidden patterns in network behavior and resource usage. To train the ML model 926, a training dataset of various log data can be utilized. Preprocessing and feature extraction may be performed to identify the most important data points. This refined data is used to train the ML model(s) 926, allowing it to learn relevant patterns.

Once trained, the ML model 926 may be integrated into the device 900 to make real-time decisions or predictions. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

Collection and analysis of the data from a computing environment can be performed by a data intake and query system such as is described herein. A data intake and query system can ingest and store data obtained from the components in a computing environment, and can enable an entity to search, analyze, and visualize the data. Through these and other capabilities, the data intake and query system can enable an entity to use the data for administration of the computing environment, to detect security issues, to understand how the computing environment is performing or being used, and/or to perform other analytics.

FIG. 10 is a block diagram illustrating an example computing environment 1000 that includes a data intake and query system 1010. The data intake and query system 1010 obtains data from a data source 1002 in the computing environment 1000 and ingests the data using an indexing system 1020. A search system 1060 of the data intake and query system 1010 enables users to navigate the indexed data. Though drawn with separate boxes in FIG. 10, in some implementations the indexing system 1020 and the search system 1060 can have overlapping components. A computing device 1004, running a network access application 1006, can communicate with the data intake and query system 1010 through a user interface system 1014 of the data intake and query system 1010. Using the computing device 1004, a user can perform various operations with respect to the data intake and query system 1010, such as administration of the data intake and query system 1010, management and generation of “knowledge objects,” (user-defined entities for enriching data, such as saved searches, event types, tags, field extractions, lookups, reports, alerts, data models, workflow actions, and fields), initiating of searches, and generation of reports, among other operations. The data intake and query system 1010 can further optionally include apps 1012 that extend the search, analytics, and/or visualization capabilities of the data intake and query system 1010.

The data intake and query system 1010 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 1010 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 1010 can be executed on a single computing device, or execution of the program code can be distributed over multiple computing devices. For example, the program code can include instructions for both indexing and search components (which may be part of the indexing system 1020 and/or the search system 1060, respectively), which can be executed on a computing device that also provides the data source 1002. As another example, the program code can be executed on one computing device, where execution of the program code provides both indexing and search components, while another copy of the program code executes on a second computing device that provides the data source 1002. As another example, the program code can be configured such that, when executed, the program code implements only an indexing component or only a search component. In this example, a first instance of the program code that is executing the indexing component and a second instance of the program code that is executing the search component can be executing on the same computing device or on different computing devices.

The data source 1002 of the computing environment 1000 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 1002 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 1020 obtains machine date from the data source 1002 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 1020 does not require prior knowledge of the structure of incoming data (e.g., the indexing system 1020 does not need to be provided with a schema describing the data). Additionally, the indexing system 1020 retains a copy of the data as it was received by the indexing system 1020 such that the original data is always available for searching (e.g., no data is discarded, though, in some examples, the indexing system 1020 can be configured to do so).

The search system 1060 searches the data stored by the indexing 1020 system. As discussed in greater detail below, the search system 1060 enables users associated with the computing environment 1000 (and possibly also other users) to navigate the data, generate reports, and visualize search results in “dashboards” output using a graphical interface. Using the facilities of the search system 1060, users can obtain insights about the data, such as retrieving events from an index, calculating metrics, searching for specific conditions within a rolling time window, identifying patterns in the data, and predicting future trends, among other examples. To achieve greater efficiency, the search system 1060 can apply map-reduce methods to parallelize searching of large volumes of data. Additionally, because the original data is available, the search system 1060 can apply a schema to the data at search time. This allows different structures to be applied to the same data, or for the structure to be modified if or when the content of the data changes. Application of a schema at search time may be referred to herein as a late-binding schema technique.

The user interface system 1014 provides mechanisms through which users associated with the computing environment 1000 (and possibly others) can interact with the data intake and query system 1010. These interactions can include configuration, administration, and management of the indexing system 1020, initiation and/or scheduling of queries that are to be processed by the search system 1060, receipt or reporting of search results, and/or visualization of search results. The user interface system 1014 can include, for example, facilities to provide a command line interface or a web-based interface.

Users can access the user interface system 1014 using a computing device 1004 that communicates with data intake and query system 1010, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 1000. For example, a person can log in as a particular user and, using the user's digital information, can access the data intake and query system 1010. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users'digital information, including assignment of user identifiers, management of security credentials, control of which persons are associated with which users, and so on.

The computing device 1004 can provide a human-machine interface through which a person can have a digital presence in the computing environment 1000 in the form of a user. The computing device 1004 is an electronic device having one or more processors and a memory capable of storing instructions for execution by the one or more processors. The computing device 1004 can further include input/output (I/O) hardware and a network interface. Applications executed by the computing device 1004 can include a network access application 1006, such as a web browser, which can use a network interface of the client computing device 1004 to communicate, over a network, with the user interface system 1014 of the data intake and query system 1010. The user interface system 1014 can use the network access application 1006 to generate user interfaces that enable a user to interact with the data intake and query system 1010. A web browser is one example of a network access application. A shell tool can also be used as a network access application. In some examples, the data intake and query system 1010 is an application executing on the computing device 1006. In such examples, the network access application 1006 can access the user interface system 1014 without going over a network.

The data intake and query system 1010 can optionally include apps 1012. An app of the data intake and query system 1010 is a collection of configurations, knowledge objects (a user-defined entity that enriches the data in the data intake and query system 1010), views, and dashboards that may provide additional functionality, different techniques for searching the data, and/or additional insights into the data. The data intake and query system 1010 can execute multiple applications simultaneously. Example applications include an information technology service intelligence application, which can monitor and analyze the performance and behavior of the computing environment 1000, and an enterprise security application, which can include content and searches to assist security analysts in diagnosing and acting on anomalous or malicious behavior in the computing environment 1000.

Though FIG. 10 illustrates only one data source, in practical implementations, the computing environment 1000 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 1000, the data intake and query system 1010 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components. “Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 1000 can include on-prem and cloud-based computing resources, or only cloud-based resources. For example, an entity may have on-prem computing devices and a private cloud. In this example, the entity operates the data intake and query system 1010 and can choose to execute the data intake and query system 1010 on an on-prem computing device or in the cloud. In another example, a provider entity operates the data intake and query system 1010 in a public cloud and provides the functionality of the data intake and query system 1010 as a service, for example under a Software-as-a-Service (SaaS) model, to entities that pay for the user of the service on a subscription basis. In this example, the provider entity can provision a separate tenant (or possibly multiple tenants) in the public cloud network for each subscriber entity, where each tenant executes a separate and distinct instance of the data intake and query system 1010. In some implementations, the entity providing the data intake and query system 1010 is itself subscribing to the cloud services of a cloud service provider. As an example, a first entity provides computing resources under a public cloud service model, a second entity subscribes to the cloud services of the first provider entity and uses the cloud computing resources to operate the data intake and query system 1010, and a third entity can subscribe to the services of the second provider entity in order to use the functionality of the data intake and query system 1010. In this example, the data sources are associated with the third entity, users accessing the data intake and query system 1010 are associated with the third entity, and the analytics and insights provided by the data intake and query system 1010 are for purposes of the third entity's operations.

FIG. 11 is a block diagram illustrating in greater detail an example of an indexing system 1120 of a data intake and query system, such as the data intake and query system 1010 of FIG. 10. The indexing system 1120 of FIG. 11 uses various methods to obtain machine data from a data source 1102 and stores the data in an index 1138 of an indexer 1132. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 1120 enables the data intake and query system to obtain the machine data produced by the data source 1102 and to store the data for searching and retrieval.

Users can administer the operations of the indexing system 1120 using a computing device 1104 that can access the indexing system 1120 through a user interface system 1114 of the data intake and query system. For example, the computing device 1104 can be executing a network access application 1106, such as a web browser or a terminal, through which a user can access a monitoring console 1116 provided by the user interface system 1114. The monitoring console 1116 can enable operations such as: identifying the data source 1102 for data ingestion; configuring the indexer 1132 to index the data from the data source 1132; configuring a data ingestion method; configuring, deploying, and managing clusters of indexers; and viewing the topology and performance of a deployment of the data intake and query system, among other operations. The operations performed by the indexing system 1120 may be referred to as “index time” operations, which are distinct from “search time” operations that are discussed further below.

The indexer 1132, which may be referred to herein as a data indexing component, coordinates and performs most of the index time operations. The indexer 1132 can be implemented using program code that can be executed on a computing device. The program code for the indexer 1132 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 1132. In some implementations, the indexer 1132 executes on the computing device 1104 through which a user can access the indexing system 1120. In some implementations, the indexer 1132 executes on a different computing device than the illustrated computing device 1104.

The indexer 1132 may be executing on the computing device that also provides the data source 1102 or may be executing on a different computing device. In implementations wherein the indexer 1132 is on the same computing device as the data source 1102, the data produced by the data source 1102 may be referred to as “local data.” In other implementations the data source 1102 is a component of a first computing device and the indexer 1132 executes on a second computing device that is different from the first computing device. In these implementations, the data produced by the data source 1102 may be referred to as “remote data.” In some implementations, the first computing device is “on-prem” and in some implementations the first computing device is “in the cloud.” In some implementations, the indexer 1132 executes on a computing device in the cloud and the operations of the indexer 1132 are provided as a service to entities that subscribe to the services provided by the data intake and query system.

For a given data produced by the data source 1102, the indexing system 1120 can be configured to use one of several methods to ingest the data into the indexer 1132. These methods include upload 1122, monitor 1124, using a forwarder 1126, or using HyperText Transfer Protocol (HTTP 1128) and an event collector 1130. These and other methods for data ingestion may be referred to as “getting data in” (GDI) methods.

Using the upload 1122 method, a user can specify a file for uploading into the indexer 1132. For example, the monitoring console 1116 can include commands or an interface through which the user can specify where the file is located (e.g., on which computing device and/or in which directory of a file system) and the name of the file. The file may be located at the data source 1102 or maybe on the computing device where the indexer 1132 is executing. Once uploading is initiated, the indexer 1132 processes the file, as discussed further below. Uploading is a manual process and occurs when instigated by a user. For automated data ingestion, the other ingestion methods are used.

The monitor 1124 method enables the indexing system 1102 to monitor the data source 1102 and continuously or periodically obtain data produced by the data source 1102 for ingestion by the indexer 1132. For example, using the monitoring console 1116, a user can specify a file or directory for monitoring. In this example, the indexing system 1102 can execute a monitoring process that detects whenever the file or directory is modified and causes the file or directory contents to be sent to the indexer 1132. As another example, a user can specify a network port for monitoring. In this example, a monitoring process can capture data received at or transmitting from the network port and cause the data to be sent to the indexer 1132. In various examples, monitoring can also be configured for data sources such as operating system event logs, performance data generated by an operating system, operating system registries, operating system directory services, and other data sources.

Monitoring is available when the data source 1102 is local to the indexer 1132 (e.g., the data source 1102 is on the computing device where the indexer 1132 is executing). Other data ingestion methods, including forwarding and the event collector 1130, can be used for either local or remote data sources.

A forwarder 1126, which may be referred to herein as a data forwarding component, is a software process that sends data from the data source 1102 to the indexer 1132. The forwarder 1126 can be implemented using program code that can be executed on the computer device that provides the data source 1102. A user launches the program code for the forwarder 1126 on the computing device that provides the data source 1102. The user can further configure the forwarder 1126, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 1126 can provide various capabilities. For example, the forwarder 1126 can send the data unprocessed or can perform minimal processing on the data before sending the data to the indexer 1132. Minimal processing can include, for example, adding metadata tags to the data to identify a source, source type, and/or host, among other information, dividing the data into blocks, and/or applying a timestamp to the data. In some implementations, the forwarder 1126 can break the data into individual events (event generation is discussed further below) and send the events to a receiver. Other operations that the forwarder 1126 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

The event collector 1130 provides an alternate method for obtaining data from the data source 1102. The event collector 1130 enables data and application events to be sent to the indexer 1132 using HTTP 1128. The event collector 1130 can be implemented using program code that can be executing on a computing device. The program code may be a component of the data intake and query system or can be a standalone component that can be executed independently of the data intake and query system and operates in cooperation with the data intake and query system.

To use the event collector 1130, a user can, for example using the monitoring console 1116 or a similar interface provided by the user interface system 1114, enable the event collector 1130 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 1102 as an alternative method to using a username and password for authentication.

To send data to the event collector 1130, the data source 1102 is supplied with a token and can then send HTTP 1128 requests to the event collector 1130. To send HTTP 1128 requests, the data source 1102 can be configured to use an HTTP client and/or to use logging libraries such as those supplied by Java, JavaScript, and . NET libraries. An HTTP client enables the data source 1102 to send data to the event collector 1130 by supplying the data, and a Uniform Resource Identifier (URI) for the event collector 1130 to the HTTP client. The HTTP client then handles establishing a connection with the event collector 1130, transmitting a request containing the data, closing the connection, and receiving an acknowledgment if the event collector 1130 sends one. Logging libraries enable HTTP 1128 requests to the event collector 1130 to be generated directly by the data source. For example, an application can include or link a logging library, and through functionality provided by the logging library manage establishing a connection with the event collector 1130, transmitting a request, and receiving an acknowledgement.

An HTTP 1128 request to the event collector 1130 can contain a token, a channel identifier, event metadata, and/or event data. The token authenticates the request with the event collector 1130. The channel identifier, if available in the indexing system 1120, enables the event collector 1130 to segregate and keep separate data from different data sources. The event metadata can include one or more key-value pairs that describe the data source 1102 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 1130 extracts events from HTTP 1128 requests and sends the events to the indexer 1132. The event collector 1130 can further be configured to send events to one or more indexers. Extracting the events can include associating any metadata in a request with the event or events included in the request. In these implementations, event generation by the indexer 1132 (discussed further below) is bypassed, and the indexer 1132 moves the events directly to indexing. In some implementations, the event collector 1130 extracts event data from a request and outputs the event data to the indexer 1132, and the indexer generates events from the event data. In some implementations, the event collector 1130 sends an acknowledgement message to the data source 1102 to indicate that the event collector 1130 has received a particular request form the data source 1102, and/or to indicate to the data source 1102 that events in the request have been added to an index.

The indexer 1132 ingests incoming data and transforms the data into searchable knowledge in the form of events. In the data intake and query system, an event is a single piece of data that represents activity of the component represented in FIG. 11 by the data source 1102. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 1132 can include a parsing module 1134 and an indexing module 1136 for generating and storing the events. The parsing module 1134 and indexing module 1136 can be modular and pipelined, such that one component can be operating on a first set of data while the second component is simultaneously operating on a second sent of data. Additionally, the indexer 1132 may at any time have multiple instances of the parsing module 1134 and indexing module 1136, with each set of instances configured to simultaneously operate on data from the same data source or from different data sources. The parsing module 1134 and indexing module 1136 are illustrated in FIG. 11 to facilitate discussion, with the understanding that implementations with other components are possible to achieve the same functionality.

The parsing module 1134 determines information about incoming event data, where the information can be used to identify events within the event data. For example, the parsing module 1134 can associate a source type with the event data. A source type identifies the data source 1102 and describes a possible data structure of event data produced by the data source 1102. For example, the source type can indicate which fields to expect in events generated at the data source 1102 and the keys for the values in the fields, and possibly other information such as sizes of fields, an order of the fields, a field separator, and so on. The source type of the data source 1102 can be specified when the data source 1102 is configured as a source of event data. Alternatively, the parsing module 1134 can determine the source type from the event data, for example from an event field in the event data or using machine learning techniques applied to the event data.

Other information that the parsing module 1134 can determine includes timestamps. In some cases, an event includes a timestamp as a field, and the timestamp indicates a point in time when the action represented by the event occurred or was recorded by the data source 1102 as event data. In these cases, the parsing module 1134 may be able to determine from the source type associated with the event data that the timestamps can be extracted from the events themselves. In some cases, an event does not include a timestamp and the parsing module 1134 determines a timestamp for the event, for example from a name associated with the event data from the data source 1102 (e.g., a file name when the event data is in the form of a file) or a time associated with the event data (e.g., a file modification time). As another example, when the parsing module 1134 is not able to determine a timestamp from the event data, the parsing module 1134 may use the time at which it is indexing the event data. As another example, the parsing module 1134 can use a user-configured rule to determine the timestamps to associate with events.

The parsing module 1134 can further determine event boundaries. In some cases, a single line (e.g., a sequence of characters ending with a line termination) in event data represents one event while in other cases, a single line represents multiple events. In yet other cases, one event may span multiple lines within the event data. The parsing module 1134 may be able to determine event boundaries from the source type associated with the event data, for example from a data structure indicated by the source type. In some implementations, a user can configure rules the parsing module 1134 can use to identify event boundaries.

The parsing module 1134 can further extract data from events and possibly also perform transformations on the events. For example, the parsing module 1134 can extract a set of fields (key-value pairs) for each event, such as a host or hostname, source or source name, and/or source type. The parsing module 1134 may extract certain fields by default or based on a user configuration. Alternatively or additionally, the parsing module 1134 may add fields to events, such as a source type or a user-configured field. As another example of a transformation, the parsing module 1134 can anonymize fields in events to mask sensitive information, such as social security numbers or account numbers. Anonymizing fields can include changing or replacing values of specific fields. The parsing component 1134 can further perform user-configured transformations.

The parsing module 1134 outputs the results of processing incoming event data to the indexing module 1136, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 1132 can be configured to identify searchable segments that are parts of fields, searchable segments that are entire fields, or both. The parsing module 1134 organizes the searchable segments into a lexicon or dictionary for the event data, with the lexicon including each searchable segment (e.g., the field “src=10.10.1.1”) and a reference to the location of each occurrence of the searchable segment within the event data (e.g., the location within the event data of each occurrence of “src=10.10.1.1”). As discussed further below, the search system can use the lexicon, which is stored in an index file 1146, to find event data that matches a search query. In some implementations, segmentation can alternatively be performed by the forwarder 1126. Segmentation can also be disabled, in which case the indexer 1132 will not build a lexicon for the event data. When segmentation is disabled, the search system searches the event data directly.

Building index data structures generates the index 1138. The index 1138 is a storage data structure on a storage device (e.g., a disk drive or other physical device for storing digital data). The storage device may be a component of the computing device on which the indexer 1132 is operating (referred to herein as local storage) or may be a component of a different computing device (referred to herein as remote storage) that the indexer 1138 has access to over a network. The indexer 1132 can manage more than one index and can manage indexes of different types. For example, the indexer 1132 can manage event indexes, which impose minimal structure on stored data and can accommodate any type of data. As another example, the indexer 1132 can manage metrics indexes, which use a highly structured format to handle the higher volume and lower latency demands associated with metrics data.

The indexing module 1136 organizes files in the index 1138 in directories referred to as buckets. The files in a bucket 1144 can include raw data files, index files, and possibly also other metadata files. As used herein, “raw data” means data as when the data was produced by the data source 1102, without alteration to the format or content. As noted previously, the parsing component 1134 may add fields to event data and/or perform transformations on fields in the event data. Event data that has been altered in this way is referred to herein as enriched data. A raw data file 1148 can include enriched data, in addition to or instead of raw data. The raw data file 1148 may be compressed to reduce disk usage. An index file 1146, which may also be referred to herein as a “time-series index” or tsidx file, contains metadata that the indexer 1132 can use to search a corresponding raw data file 1148. As noted above, the metadata in the index file 1146 includes a lexicon of the event data, which associates each unique keyword in the event data with a reference to the location of event data within the raw data file 1148. The keyword data in the index file 1146 may also be referred to as an inverted index. In various implementations, the data intake and query system can use index files for other purposes, such as to store data summarizations that can be used to accelerate searches.

A bucket 1144 includes event data for a particular range of time. The indexing module 1136 arranges buckets in the index 1138 according to the age of the buckets, such that buckets for more recent ranges of time are stored in short-term storage 1140 and buckets for less recent ranges of time are stored in long-term storage 1142. Short-term storage 1140 may be faster to access while long-term storage 1142 may be slower to access. Buckets may be moves from short-term storage 1140 to long-term storage 1142 according to a configurable data retention policy, which can indicate at what point in time a bucket is old enough to be moved.

A bucket's location in short-term storage 1140 or long-term storage 1142 can also be indicated by the bucket's status. As an example, a bucket's status can be “hot,” “warm,” “cold,” “frozen,” or “thawed.” In this example, hot bucket is one to which the indexer 1132 is writing data and the bucket becomes a warm bucket when the index 1132 stops writing data to it. In this example, both hot and warm buckets reside in short-term storage 1140. Continuing this example, when a warm bucket is moved to long-term storage 1142, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 1120 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each buckets must exist within the cluster), and indexers to which buckets are copied may be selected to optimize distribution of data across the cluster.

A user can view the performance of the indexing system 1120 through the monitoring console 1116 provided by the user interface system 1114. Using the monitoring console 1116, the user can configure and monitor an index cluster, and see information such as disk usage by an index, volume usage by an indexer, index and volume size over time, data age, statistics for bucket types, and bucket settings, among other information.

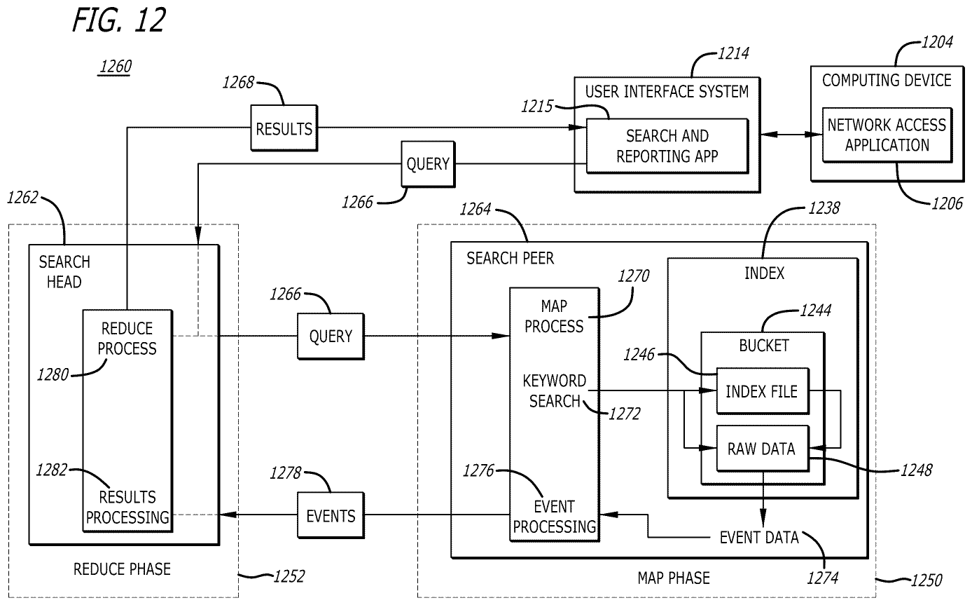

FIG. 12 is a block diagram illustrating in greater detail an example of the search system 1260 of a data intake and query system, such as the data intake and query system 1010 of FIG. 10. The search system 1260 of FIG. 12 issues a query 1266 to a search head 1262, which sends the query 1266 to a search peer 1264. Using a map process 1270, the search peer 1264 searches the appropriate index 1238 for events identified by the query 1266 and sends events 1278 so identified back to the search head 1262. Using a reduce process 1282, the search head 1262 processes the events 1278 and produces results 1268 to respond to the query 1266. The results 1268 can provide useful insights about the data stored in the index 1238. These insights can aid in the administration of information technology systems, in security analysis of information technology systems, and/or in analysis of the development environment provided by information technology systems.

The query 1266 that initiates a search is produced by a search and reporting app 1216 that is available through the user interface system 1214 of the data intake and query system. Using a network access application 1206 executing on a computing device 1204, a user can input the query 1266 into a search field provided by the search and reporting app 1216. Alternatively or additionally, the search and reporting app 1216 can include pre-configured queries or stored queries that can be activated by the user. In some cases, the search and reporting app 1216 initiates the query 1266 when the user enters the query 1266. In these cases, the query 1266 maybe referred to as an “ad-hoc” query. In some cases, the search and reporting app 1216 initiates the query 1266 based on a schedule. For example, the search and reporting app 1216 can be configured to execute the query 1266 once per hour, once per day, at a specific time, on a specific date, or at some other time that can be specified by a date, time, and/or frequency. These types of queries maybe referred to as scheduled queries.

The query 1266 is specified using a search processing language. The search processing language includes commands or search terms that the search peer 1264 will use to identify events to return in the search results 1268. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 1266 to include sequential commands, where a subsequent command may operate on the results of a prior command. As an example, sequential commands may be separated in the query 1266 by a vertical line (“|” or “pipe”) symbol.

In addition to one or more search commands, the query 1266 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 1266 occurs in two broad phases: a map phase 1250 and a reduce phase 1252. The map phase 1250 takes place across one or more search peers. In the map phase 1250, the search peers locate event data that matches the search terms in the search query 1266 and sorts the event data into field-value pairs. When the map phase 1250 is complete, the search peers send events that they have found to one or more search heads for the reduce phase 1252. During the reduce phase 1252, the search heads process the events through commands in the search query 1266 and aggregate the events to produce the final search results 1268.

A search head, such as the search head 1262 illustrated in FIG. 12, is a component of the search system 1260 that manages searches. The search head 1262, which may also be referred to herein as a search management component, can be implemented using program code that can be executed on a computing device. The program code for the search head 1262 can be stored on a non-transitory computer-readable medium and from this medium can be loaded or copied to the memory of a computing device. One or more hardware processors of the computing device can read the program code from the memory and execute the program code in order to implement the operations of the search head 1262.

Upon receiving the search query 1266, the search head 1262 directs the query 1266 to one or more search peers, such as the search peer 1264 illustrated in FIG. 12. “Search peer” is an alternate name for “indexer” and a search peer may be largely similar to the indexer described previously. The search peer 1264 may be referred to as a “peer node” when the search peer 1264 is part of an indexer cluster. The search peer 1264, which may also be referred to as a search execution component, can be implemented using program code that can be executed on a computing device. In some implementations, one set of program code implements both the search head 1262 and the search peer 1264 such that the search head 1262 and the search peer 1264 form one component. In some implementations, the search head 1262 is an independent piece of code that performs searching and no indexing functionality. In these implementations, the search head 1262 may be referred to as a dedicated search head.

The search head 1262 may consider multiple criteria when determining whether to send the query 1266 to the particular search peer 1264. For example, the search system 1260 may be configured to include multiple search peers that each have duplicative copies of at least some of the event data and are implanted using different hardware resources q. In this example, the sending the search query 1266 to more than one search peer allows the search system 1260 to distribute the search workload across different hardware resources. As another example, search system 1260 may include different search peers for different purposes (e.g., one has an index storing a first type of data or from a first data source while a second has an index storing a second type of data or from a second data source). In this example, the search query 1266 may specify which indexes to search, and the search head 1262 will send the query 1266 to the search peers that have those indexes.

To identify events 1278 to send back to the search head 1262, the search peer 1264 performs a map process 1270 to obtain event data 1274 from the index 1238 that is maintained by the search peer 1264. During a first phase of the map process 1270, the search peer 1264 identifies buckets that have events that are described by the time indicator in the search query 1266. As noted above, a bucket contains events whose timestamps fall within a particular range of time. For each bucket 1244 whose events can be described by the time indicator, during a second phase of the map process 1270, the search peer 1264 performs a keyword search 1274 using search terms specified in the search query 1266. The search terms can be one or more of keywords, phrases, fields, Boolean expressions, and/or comparison expressions that in combination describe events being searched for. When segmentation is enabled at index time, the search peer 1264 performs the keyword search 1272 on the bucket's index file 1246. As noted previously, the index file 1246 includes a lexicon of the searchable terms in the events stored in the bucket's raw data 1248 file. The keyword search 1272 searches the lexicon for searchable terms that correspond to one or more of the search terms in the query 1266. As also noted above, the lexicon incudes, for each searchable term, a reference to each location in the raw data 1248 file where the searchable term can be found. Thus, when the keyword search identifies a searchable term in the index file 1246 that matches a search term in the query 1266, the search peer 1264 can use the location references to extract from the raw data 1248 file the event data 1274 for each event that include the searchable term.

In cases where segmentation was disabled at index time, the search peer 1264 performs the keyword search 1272 directly on the raw data 1248 file. To search the raw data 1248, the search peer 1264 may identify searchable segments in events in a similar manner as when the data was indexed. Thus, depending on how the search peer 1264 is configured, the search peer 1264 may look at event fields and/or parts of event fields to determine whether an event matches the query 1266. Any matching events can be added to the event data 1274 read from the raw data 1248 file. The search peer 1264 can further be configured to enable segmentation at search time, so that searching of the index 1238 causes the search peer 1264 to build a lexicon in the index file 1246.

The event data 1274 obtained from the raw data 1248 file includes the full text of each event found by the keyword search 1272. During a third phase of the map process 1270, the search peer 1264 performs event processing 1276 on the event data 1274, with the steps performed being determined by the configuration of the search peer 1264 and/or commands in the search query 1266. For example, the search peer 1264 can be configured to perform field discovery and field extraction. Field discovery is a process by which the search peer 1264 identifies and extracts key-value pairs from the events in the event data 1274. The search peer 1264 can, for example, be configured to automatically extract the first 100 fields (or another number of fields) in the event data 1274 that can be identified as key-value pairs. As another example, the search peer 1264 can extract any fields explicitly mentioned in the search query 1266. The search peer 1264 can, alternatively or additionally, be configured with particular field extractions to perform.

Other examples of steps that can be performed during event processing 1276 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 1264 sends processed events 1278 to the search head 1262, which performs a reduce process 1280. The reduce process 1280 potentially receives events from multiple search peers and performs various results processing 1282 steps on the received events. The results processing 1282 steps can include, for example, aggregating the events received from different search peers into a single set of events, deduplicating and aggregating fields discovered by different search peers, counting the number of events found, and sorting the events by timestamp (e.g., newest first or oldest first), among other examples. Results processing 1282 can further include applying commands from the search query 1266 to the events. The query 1266 can include, for example, commands for evaluating and/or manipulating fields (e.g., to generate new fields from existing fields or parse fields that have more than one value). As another example, the query 1266 can include commands for calculating statistics over the events, such as counts of the occurrences of fields, or sums, averages, ranges, and so on, of field values. As another example, the query 1266 can include commands for generating statistical values for purposes of generating charts of graphs of the events.

The reduce process 1280 outputs the events found by the search query 1266, as well as information about the events. The search head 1262 transmits the events and the information about the events as search results 1268, which are received by the search and reporting app 1216. The search and reporting app 1216 can generate visual interfaces for viewing the search results 1268. The search and reporting app 1216 can, for example, output visual interfaces for the network access application 1206 running on a computing device 1204 to generate.

The visual interfaces can include various visualizations of the search results 1268, such as tables, line or area charts, Choropleth maps, or single values. The search and reporting app 1216 can organize the visualizations into a dashboard, where the dashboard includes a panel for each visualization. A dashboard can thus include, for example, a panel listing the raw event data for the events in the search results 1268, a panel listing fields extracted at index time and/or found through field discovery along with statistics for those fields, and/or a timeline chart indicating how many events occurred at specific points in time (as indicated by the timestamps associated with each event). In various implementations, the search and reporting app 1216 can provide one or more default dashboards. Alternatively or additionally, the search and reporting app 1216 can include functionality that enables a user to configure custom dashboards.

The search and reporting app 1216 can also enable further investigation into the events in the search results 1216. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 1266. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

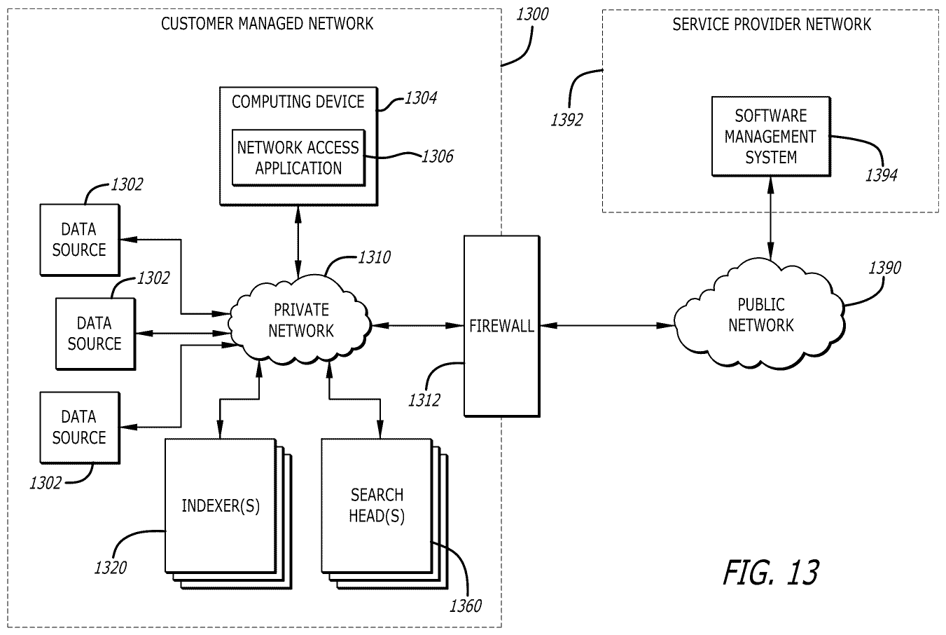

FIG. 13 illustrates an example of a self-managed network 1300 that includes a data intake and query system. “Self-managed” in this instance means that the entity that is operating the self-managed network 1300 configures, administers, maintains, and/or operates the data intake and query system using its own compute resources and people. Further, the self-managed network 1300 of this example is part of the entity's on-premise network and comprises a set of compute, memory, and networking resources that are located, for example, within the confines of an entity's data center. These resources can include software and hardware resources. The entity can, for example, be a company or enterprise, a school, government entity, or other entity. Since the self-managed network 1300 is located within the customer's on-prem environment, such as in the entity's data center, the operation and management of the self-managed network 1300, including of the resources in the self-managed network 1300, is under the control of the entity. For example, administrative personnel of the entity have complete access to and control over the configuration, management, and security of the self-managed network 1300 and its resources.

The self-managed network 1300 can execute one or more instances of the data intake and query system. An instance of the data intake and query system may be executed by one or more computing devices that are part of the self-managed network 1300. A data intake and query system instance can comprise an indexing system and a search system, where the indexing system includes one or more indexers 1320 and the search system includes one or more search heads 1360.

As depicted in FIG. 13, the self-managed network 1300 can include one or more data sources 1302. Data received from these data sources may be processed by an instance of the data intake and query system within self-managed network 1300. The data sources 1302 and the data intake and query system instance can be communicatively coupled to each other via a private network 1310.

Users associated with the entity can interact with and avail themselves of the functions performed by a data intake and query system instance using computing devices. As depicted in FIG. 13, a computing device 1304 can execute a network access application 1306 (e.g., a web browser), that can communicate with the data intake and query system instance and with data sources 1302 via the private network 1310. Using the computing device 1304, a user can perform various operations with respect to the data intake and query system, such as management and administration of the data intake and query system, generation of knowledge objects, and other functions. Results generated from processing performed by the data intake and query system instance may be communicated to the computing device 1304 and output to the user via an output system (e.g., a screen) of the computing device 1304.

The self-managed network 1300 can also be connected to other networks that are outside the entity's on-premise environment/network, such as networks outside the entity's data center. Connectivity to these other external networks is controlled and regulated through one or more layers of security provided by the self-managed network 1300. One or more of these security layers can be implemented using firewalls 1312. The firewalls 1312 form a layer of security around the self-managed network 1300 and regulate the transmission of traffic from the self-managed network 1300 to the other networks and from these other networks to the self-managed network 1300.

Networks external to the self-managed network can include various types of networks including public networks 1390, other private networks, and/or cloud networks provided by one or more cloud service providers. An example of a public network 1390 is the Internet. In the example depicted in FIG. 13, the self-managed network 1300 is connected to a service provider network 1392 provided by a cloud service provider via the public network 1390.

In some implementations, resources provided by a cloud service provider may be used to facilitate the configuration and management of resources within the self-managed network 1300. For example, configuration and management of a data intake and query system instance in the self-managed network 1300 may be facilitated by a software management system 1394 operating in the service provider network 1392. There are various ways in which the software management system 1394 can facilitate the configuration and management of a data intake and query system instance within the self-managed network 1300. As one example, the software management system 1394 may facilitate the download of software including software updates for the data intake and query system. In this example, the software management system 1394 may store information indicative of the versions of the various data intake and query system instances present in the self-managed network 1300. When a software patch or upgrade is available for an instance, the software management system 1394 may inform the self-managed network 1300 of the patch or upgrade. This can be done via messages communicated from the software management system 1394 to the self-managed network 1300.

The software management system 1394 may also provide simplified ways for the patches and/or upgrades to be downloaded and applied to the self-managed network 1300. For example, a message communicated from the software management system 1394 to the self-managed network 1300 regarding a software upgrade may include a Uniform Resource Identifier (URI) that can be used by a system administrator of the self-managed network 1300 to download the upgrade to the self-managed network 1300. In this manner, management resources provided by a cloud service provider using the service provider network 1392 and which are located outside the self-managed network 1300 can be used to facilitate the configuration and management of one or more resources within the entity's on-prem environment. In some implementations, the download of the upgrades and patches may be automated, whereby the software management system 1394 is authorized to, upon determining that a patch is applicable to a data intake and query system instance inside the self-managed network 1300, automatically communicate the upgrade or patch to self-managed network 1300 and cause it to be installed within self-managed network 1300.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A computer-implemented method, comprising:
obtaining log data comprising a plurality of log entries, wherein each log entry includes an indicator of a state of an action or resource, and a timestamp;
sorting the plurality of log entries based on the timestamp of each log entry resulting in a sorted set of log entries;
identifying sequential blocks of log entries from the sorted set of log entries, wherein each sequential block of log entries includes a same status of the action or the resource, and wherein each sequential block of log entries begins with a log entry indicating a different state of the action or the resource compared to an immediately prior log entry;
performing a programmatic behavior analysis on the sequential blocks of log entries resulting in a determination as to whether the log entries were generated by repeated execution of a benign programmatic script; and
responsive to determining the sequential blocks of log entries were not generated by repeated execution of the benign programmatic script, determining the log entries indicate anomalous behavior and initiating one or more automated remediation operations.

2. The computer-implemented method of claim 1, wherein the log data is authentication log data comprised of a plurality of authentication attempt entries, wherein each authentication attempt entry includes an authentication attempt status and a timestamp.

3. The computer-implemented method of claim 2, wherein the one or more automated remediation operations include:
identifying a user account to which the plurality of authentication attempt entries corresponds, and
locking the user account thereby preventing access thereto.

4. The computer-implemented method of claim 1, wherein the log data is network transmission log data comprised of a plurality of network transmission attempt entries, wherein each of the plurality of network transmission attempt entries originate from a first source address and includes an indicator of a transmission attempt status and a timestamp.

5. The computer-implemented method of claim 1, wherein the programmatic behavior analysis includes:
determining a sequence length for each of the sequential blocks,
determining, based on the sequence length for each of the sequential blocks, whether a sequential pattern exists within the log entries that is indicative of repeated execution of a benign programmatic script, and
responsive to a determination that no such sequential pattern exists within the log entries that is indicative of the repeated execution of the benign programmatic script, determining the log entries are indicative of anomalous behavior.

6. The computer-implemented method of claim 1, wherein the one or more automated remediation operations includes adjusting a risk score associated with the log data in a cybersecurity system.

7. The computer-implemented method of claim 1, further comprising:
responsive to determining the sequential blocks of log entries were generated by repeated execution of the benign programmatic script, identifying the benign programmatic script.

8. A computing device, comprising:
a processor; and
a non-transitory computer-readable medium having stored thereon instructions that, when executed by the processor, cause the processor to perform operations including:
obtaining log data comprising a plurality of log entries, wherein each log entry includes an indicator of a state of an action or resource, and a timestamp,
sorting the plurality of log entries based on the timestamp of each log entry resulting in a sorted set of log entries,
identifying sequential blocks of log entries from the sorted set of log entries, wherein each sequential block of log entries includes a same status of the action or the resource, and wherein each sequential block of log entries begins with a log entry indicating a different state of the action or the resource compared to an immediately prior log entry,
performing a programmatic behavior analysis on the sequential blocks of log entries resulting in a determination as to whether the log entries were generated by repeated execution of a benign programmatic script, and
responsive to determining the sequential blocks of log entries were not generated by repeated execution of the benign programmatic script, determining the log entries indicate anomalous behavior and initiating one or more automated remediation operations.

9. The computing device of claim 8, wherein the log data is authentication log data comprised of a plurality of authentication attempt entries, wherein each authentication attempt entry includes an authentication attempt status and a timestamp.

10. The computing device of claim 9, wherein the one or more automated remediation operations include:
identifying a user account to which the plurality of authentication attempt entries corresponds, and
locking the user account thereby preventing access thereto.

11. The computing device of claim 8, wherein the log data is network transmission log data comprised of a plurality of network transmission attempt entries, wherein each of the plurality of network transmission attempt entries originate from a first source address and includes an indicator of a transmission attempt status and a timestamp.

12. The computing device of claim 8, wherein the programmatic behavior analysis includes:
determining a sequence length for each of the sequential blocks,
determining, based on the sequence length for each of the sequential blocks, whether a sequential pattern exists within the log entries that is indicative of repeated execution of a benign programmatic script, and
responsive to a determination that no such sequential pattern exists within the log entries that is indicative of the repeated execution of the benign programmatic script, determining the log entries are indicative of anomalous behavior.

13. The computing device of claim 8, wherein the one or more automated remediation operations includes adjusting a risk score associated with the log data in a cybersecurity system.

14. The computing device of claim 8, wherein the operations further comprise:
responsive to determining the sequential blocks of log entries were generated by repeated execution of the benign programmatic script, identifying the benign programmatic script.

15. A non-transitory computer-readable medium having stored thereon instructions that, when executed by one or more processors, cause the one or more processors to perform operations including:
obtaining log data comprising a plurality of log entries, wherein each log entry includes an indicator of a state of an action or resource, and a timestamp;
sorting the plurality of log entries based on the timestamp of each log entry resulting in a sorted set of log entries;
identifying sequential blocks of log entries from the sorted set of log entries, wherein each sequential block of log entries includes a same status of the action or the resource, and wherein each sequential block of log entries begins with a log entry indicating a different state of the action or the resource compared to an immediately prior log entry;
performing a programmatic behavior analysis on the sequential blocks of log entries resulting in a determination as to whether the log entries were generated by repeated execution of a benign programmatic script; and
responsive to determining the sequential blocks of log entries were not generated by repeated execution of the benign programmatic script, determining the log entries indicate anomalous behavior and initiating one or more automated remediation operations.

16. The non-transitory computer-readable medium of claim 15, wherein the log data is authentication log data comprised of a plurality of authentication attempt entries, wherein each authentication attempt entry includes an authentication attempt status and a timestamp, and wherein the one or more automated remediation operations include:
identifying a user account to which the plurality of authentication attempt entries correspond, and
locking the user account thereby preventing access thereto.

17. The non-transitory computer-readable medium of claim 15, wherein the log data is network transmission log data comprised of a plurality of network transmission attempt entries, wherein each of the plurality of network transmission attempt entries originate from a first source address and includes an indicator of a transmission attempt status and a timestamp.

18. The non-transitory computer-readable medium of claim 15, wherein the programmatic behavior analysis includes:
determining a sequence length for each of the sequential blocks,
determining, based on the sequence length for each of the sequential blocks, whether a sequential pattern exists within the log entries that is indicative of repeated execution of a benign programmatic script, and
responsive to a determination that no such sequential pattern exists within the log entries that is indicative of the repeated execution of the benign programmatic script, determining the log entries are indicative of anomalous behavior.

19. The non-transitory computer-readable medium of claim 15, wherein the one or more automated remediation operations includes adjusting a risk score associated with the log data in a cybersecurity system.

20. The non-transitory computer-readable medium of claim 15, wherein the operations further comprise:
responsive to determining the sequential blocks of log entries were generated by repeated execution of the benign programmatic script, identifying the benign programmatic script.
